(19) United States
(12) Patent Application Publication
(10) Pub. No.: US 2023/0207965 A1
(43) Pub. Date: Jun. 29, 2023

(54) LDH-LIKE COMPOUND SEPARATOR AND ZINC SECONDARY BATTERY

(71) Applicant: NGK INSULATORS, LTD., Nagoya-City (JP)

(72) Inventors: Sota OKOCHI, Nishio-city (JP); Shohei YOKOYAMA, Nagoya-City (JP); Naoko INUKAI, Nagoya-City (JP); Sho YAMAMOTO, Nagoya-City (JP)

(73) Assignee: NGK INSULATORS, LTD., Nagoya-City (JP)

(21) Appl. No.: 18/167,176

(22) Filed: Feb. 10, 2023

Related U.S. Application Data
(63) Continuation of application No. PCT/JP2021/030376, filed on Aug. 19, 2021.

(30) Foreign Application Priority Data
Dec. 1, 2020 (JP) 2020-199924

(51) Int. Cl. H01M 50/449; H01M 50/417; H01M 50/434; H01M 50/489; H01M 10/24

(52) U.S. Cl. CPC H01M 50/449; H01M 10/24; H01M 50/417; H01M 50/434; H01M 50/489

(57) ABSTRACT

Provided is an LDH-like compound separator for secondary zinc batteries that includes a porous substrate made of a polymer material; and an LDH-like compound plugging pores in the porous substrate. The LDH-like compound separator has a dendrite buffer layer therein, the dendrite buffer layer being at least one selected from the group consisting of: (i) a pore-rich internal porous layer in the porous substrate, the internal porous layer being free from the LDH-like compound or deficient in the LDH-like compound; (ii) a releasable interfacial layer, which is provided by two adjacent layers constituting part of the LDH-like compound separator being in releasable contact with each other; and (iii) an internal gap layer being free from the LDH-like compound and the porous substrate, which is provided by two adjacent layers constituting part of the LDH-like compound separator being formed apart from each other.

### CROSS-REFERENCE TO RELATED APPLICATIONS

This application is a Continuation Application of PCT/JP2021/030376 filed Aug. 19, 2021, which claims priority to Japanese Patent Application No. 2020-199924 filed Dec. 1, 2020, the entire contents all of which are incorporated herein by reference.

### BACKGROUND OF THE INVENTION

### 1. Field of the Invention

The present invention relates to an LDH-like compound separator and a secondary zinc battery.

### 2. Description of the Related Art

In secondary zinc batteries, such as secondary nickel-zinc batteries and secondary air-zinc batteries, it is known that metallic zinc dendrites precipitate on negative electrodes during a charge mode, penetrate through voids in separators composed of, for example, non-woven fabrics, and reach positive electrodes, resulting in short circuit. The short circuit caused by such zinc dendrites occurs during repeated charge/discharge operations, leading to a reduction in service lives of the secondary zinc batteries.

In order to solve such a problem, secondary zinc batteries have been proposed that include layered double hydroxide (LDH) separators that selectively permeate hydroxide ions while blocking the penetration of zinc dendrites. For example, Patent Literature 1 (WO2013/118561) discloses a secondary nickel-zinc battery including an LDH separator disposed between a positive electrode and a negative electrode. Patent Literature 2 (WO2016/076047) discloses a separator structure including an LDH separator that is fit in or joined to a resin frame and is dense enough to restrict permeation of gas and/or water. Patent Literature 2 also discloses that the LDH separator may be a composite with a porous substrate. In addition, Patent Literature 3 (WO2016/067884) discloses various methods for forming a dense LDH membrane on the surface of a porous substrate to give a composite material (an LDH separator). These methods include the steps of: uniformly bonding an initiating material capable of giving origins of crystal growth of LDH to the porous substrate; and then subjecting the porous substrate to hydrothermal treatment in an aqueous raw material solution to form a dense LDH membrane on the surface of the porous substrate.

In the meantime, Patent Literature 4 (WO2019/131688) discloses an LDH separator for secondary zinc batteries, comprising a porous substrate made of a polymer material; and a layered double hydroxide (LDH) plugging pores in the porous substrate, where the LDH separator has in its inside a dendrite buffer layer. This dendrite buffer layer is at least one selected from the group consisting of: (i) a pore-rich internal porous layer in the porous substrate, which is free from the LDH or deficient in the LDH; (ii) a releasable interfacial layer, which is provided by two adjacent layers constituting part of the LDH separator being in releasable contact with each other; and (iii) an internal gap layer being free from the LDH and the porous substrate, which is provided by two adjacent layers constituting part of the LDH separator being formed apart from each other.

### CITATION LIST

### Patent Literature

Patent Literature 1: WO2013/118561
Patent Literature 2: WO2016/076047
Patent Literature 3: WO2016/067884
Patent Literature 4: WO2019/131688

### SUMMARY OF THE INVENTION

Secondary zinc batteries, for example, nickel-zinc batteries, constructed with the LDH separator as described above usually do not cause short circuit by zinc dendrites; however, penetration of zinc dendrites and thus short circuit between positive and negative electrodes may eventually occur in an abnormal situation, i.e., intrusion of zinc dendrites into the LDH separator due to, for example, some defects. Accordingly, a further improvement is desired for a preventive effect of the short circuit caused by the dendrites.

The inventors have now found that by using an LDH-like compound described hereinafter as a hydroxide ion-conductive substance instead of conventional LDHs, it is possible to provide a hydroxide ion-conductive separator (LDH-like compound separator) having excellent alkali resistance and capable of suppressing short circuits due to zinc dendrites further effectively. The inventors have also found that an LDH-like compound separator that can more effectively restrain the short circuit caused by zinc dendrites can be provided through providing a dendrite buffer layer with a predetermined configuration inside the LDH-like compound separator.

Accordingly, an object of the present invention is to provide a hydroxide ion-conductive separator having excellent alkali resistance and capable of suppressing short circuits due to zinc dendrites further effectively, which is superior to the LDH separator.

According to an aspect of the present invention, there is provided an LDH-like compound separator for secondary zinc batteries, comprising a porous substrate made of a polymer material; and a layered double hydroxide (LDH)-like compound plugging pores in the porous substrate, wherein the LDH-like compound separator has in its inside a dendrite buffer layer, wherein the dendrite buffer layer is at least one selected from the group consisting of:
(i) a pore-rich internal porous layer in the porous substrate, the internal porous layer being free from the LDH-like compound or deficient in the LDH-like compound;
(ii) a releasable interfacial layer, which is provided by two adjacent layers constituting part of the LDH-like compound separator being in releasable contact with each other; and
(iii) an internal gap layer being free from the LDH-like compound and the porous substrate, which is provided by two adjacent layers constituting part of the LDH-like compound separator being formed apart from each other.

According to another aspect of the present invention, there is provided a secondary zinc battery comprising the LDH-like compound separator described above.

### BRIEF DESCRIPTION OF THE DRAWINGS

FIG. 1 is a schematic cross-sectional view illustrating an LDH-like compound separator including an internal porous layer functioning as a dendrite buffer layer.

FIG. 2 is a schematic cross-sectional view illustrating an LDH-like compound separator including a releasable interfacial layer functioning as a dendrite buffer layer.

FIG. 3 is a schematic cross-sectional view illustrating an LDH-like compound separator including an internal gap layer functioning as a dendrite buffer layer.

FIG. 4A is an exploded perspective view of a closed container used in the determination of density in Examples A1 to A4.

FIG. 4B is a schematic cross-sectional view of the measurement system used in the determination of density in Examples A1 to A4.

FIG. 5 is a schematic cross-sectional view of a measurement device used in the determination of short circuit caused by dendrites in Examples A1 to A4.

FIG. 6A is a conceptual view illustrating an example system for measuring helium permeability used in Examples A1 to A4.

FIG. 6B is a schematic cross-sectional view of a sample holder and its peripheral configuration used in the measurement system shown in FIG. 6A.

FIG. 7A is a cross-sectional SEM image of the LDH separator produced in Example A1.

FIG. 7B is a cross-sectional SEM image of the LDH separator produced in Example A1.

FIG. 8 is a cross-sectional SEM image of the LDH separator produced in Example A2.

FIG. 9 is a cross-sectional SEM image of the LDH separator produced in Example A3.

FIG. 10 is a cross-sectional SEM image of the LDH separator produced in Example A2 after the test of short circuit caused by dendrites. D indicates a dendrite in the image.

FIG. 11 is a schematic sectional view showing an electrochemical measurement system used in Examples B1 to D3.

FIG. 12A is an SEM image of a surface of an LDH-like compound produced in Example B1.

FIG. 12B is the result of X-ray diffraction of the LDH-like compound separator produced in Example B1.

FIG. 13A is an SEM image of a surface of an LDH-like compound separator produced in Example B2.

FIG. 13B is the result of X-ray diffraction of the LDH-like compound separator produced in Example B2.

FIG. 14A is an SEM image of a surface of an LDH-like compound separator produced in Example B3.

FIG. 14B is the result of X-ray diffraction of the LDH-like compound separator produced in Example B3.

FIG. 15A is an SEM image of a surface of an LDH-like compound separator produced in Example B4.

FIG. 15B is the result of X-ray diffraction of the LDH-like compound separator produced in Example B4.

FIG. 16A is an SEM image of a surface of an LDH-like compound separator produced in Example B5.

FIG. 16B is the result of X-ray diffraction of the LDH-like compound separator produced in Example B5.

FIG. 17A is an SEM image of a surface of an LDH-like compound separator produced in Example B6.

FIG. 17B is the result of X-ray diffraction of the LDH-like compound separator produced in Example B6.

FIG. 18 is an SEM image of a surface of an LDH-like compound separator produced in Example B7.

FIG. 19A is an SEM image of a surface of an LDH separator produced in Example B8 (comparison).

FIG. 19B is the result of X-ray diffraction of the LDH separator produced in Example B8 (comparison).

FIG. 20 is an SEM image of a surface of the LDH-like compound separator produced in Example C1.

FIG. 21 is an SEM image of a surface of the LDH-like compound separator produced in Example D1.

FIG. 22 is an SEM image of a surface of the LDH-like compound separator produced in Example D2.

### DETAILED DESCRIPTION OF THE INVENTION

### LDH-Like Compound Separator

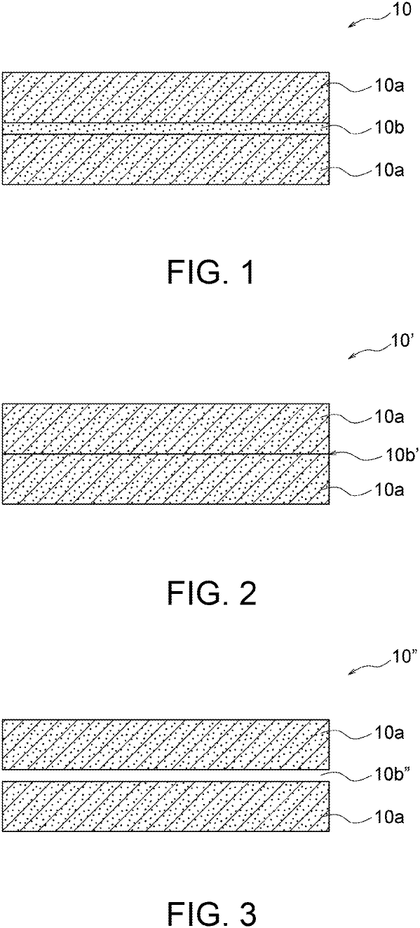

The LDH-like compound separator of the present invention, which is used in secondary zinc batteries, comprises a porous substrate and a layered double hydroxide (LDH)-like compound. The “LDH-like compound separator” is defined herein as a separator including an LDH-like compound and configured to selectively pass hydroxide ions exclusively by means of the hydroxide ion conductivity of the LDH-like compound. The “LDH-like compound” is defined herein as a hydroxide and/or an oxide having a layered crystal structure that cannot be called LDH but is analogous to LDH, for which no peak attributable to LDH is detected in X-ray diffraction method. The porous substrate is composed of a polymeric material, and the pores in the porous substrate are filled with the LDH-like compound. The LDH-like compound separator has in its inside a dendrite buffer layer. The dendrite buffer layer may include: (i) a pore-rich internal porous layer 10b in the porous substrate, the internal porous layer 10b being free from the LDH-like compound or deficient in the LDH-like compound, as shown in FIG. 1; (ii) a releasable interfacial layer 10b′, which is provided by two adjacent layers constituting part of the LDH-like compound separator being in releasable contact with each other, as shown in FIG. 2; or (iii) an internal gap layer 10b″ (free from the LDH-like compound and the porous substrate), which is provided by two adjacent layers constituting part of the LDH-like compound separator being apart from each other, as shown in FIG. 3. As described above, at least one dendrite buffer layer selected from the group consisting of (i), (ii) and (iii) provided inside the LDH-like compound separator can more effectively restrain the short circuit caused by the zinc dendrites.

As described above, a secondary zinc battery, such as a nickel-zinc battery, constructed with a conventional LDH separator usually can prevent short circuit caused by zinc dendrites; however, penetration of zinc dendrites and thus short circuit between positive and negative electrodes may eventually occur in an abnormal situation, i.e., intrusion of zinc dendrites into the LDH separator due to, for example, some defects. It is presumed that the penetration of zinc dendrites through the conventional separator occurs based on the following mechanism: (a) the zinc dendrites intrude into voids or defects contained in the separator; (b) the dendrites grow and develop while expanding the separator, and then (c) the dendrites eventually penetrate through the separator. In contrast, the LDH-like compound separator of the present invention is intentionally provided with a dendrite buffer layer, inside the separator, that has a configuration in a manner such as above (i) to (iii) to allow the zinc dendrites to grow, and the deposition and growth of zinc dendrites D can be confined only in the dendrite buffer layer, for example, shown in FIG. 10, resulting in prevention or significant delay of the penetration of the dendrites through the separator, and thereby more effectively blocking of the short circuit caused by the zinc dendrites. In particular, by using an LDH-like compound described hereinafter as a hydroxide ion-conductive substance instead of conventional LDHs, it is possible to provide a hydroxide ion-conductive separator (LDH-like compound separator) having excellent alkali resistance and capable of suppressing short circuits due to zinc dendrites further effectively.

Furthermore, the LDH-like compound separator of the present invention has excellent flexibility and strength, as well as a desired ionic conductivity based on the hydroxide ionic conductivity of the LDH-like compound. The flexibility and strength are caused by those of the polymeric porous substrate itself of the LDH-like compound separator. In other words, the LDH-like compound separator is densified in such a manner that the pores of the porous polymer substrate are filled with the LDH-like compound, thereby high rigidity and low ductility caused by the LDH-like compound, which is ceramic material, can be balanced with or reduced by high flexibility and high strength of the porous polymeric substrate.

In a preferred embodiment of the present invention, the dendrite buffer layer is (i) a pore-rich internal porous layer 10b in the porous substrate, the internal porous layer being free from the LDH-like compound or deficient in the LDH-like compound as the LDH-like compound separator 10 shown in FIG. 1. In other words, the LDH-like compound separator 10 of the present embodiment includes a pair of LDH-like compound separator bodies 10a including the porous substrate and the LDH-like compound, and an internal porous layer 10b interposed between the LDH separator bodies 10a. The internal porous layer 10b consists of a porous substrate or includes a porous substrate and a reduced amount or density of the LDH-like compound. The LDH-like compound separator bodies 10a may have the same configuration as the conventional LDH-like compound separators disclosed in Patent Literatures 1 to 3, and thus can exhibit the same preventive advantage to short circuit caused by dendrites as the conventional LDH-like compound separator. However, a further improvement is desired as described above. In the present embodiment, the internal porous layer 10b that has pore-rich portions of the porous substrate and is free from or deficient in the LDH-like compound is interposed between the pair of LDH-like compound separator bodies10a; hence, zinc dendrites are preferentially deposited and grown in the pores not filled with the LDH-like compound of the porous substrate, and the deposition and growth of zinc dendrite are confined only within the internal porous layer 10b, resulting in blocking or significantly delaying the penetration of the dendrites through the separator. The LDH-like compound separator 10 of the present embodiment can be manufactured by depositing the LDH-like compound such that a single sheet of the porous substrate has higher density at two sides and low density in a central region across the thickness. This deposition process can be carried out through, for example, immersing the porous substrate in a solvent such as ethanol immediately before dip coating the porous substrate with alumina/titania mixed sol, and blocking impregnation of the mixed sol into the central region across the thickness of the porous substrate. The internal porous layer 10b has a thickness of preferably 0.5 mm or less, more preferably 0.3 mm or less, further more preferably 0.1 mm or less, particularly more preferably 0.05 mm or less, most preferably 0.01 mm or less. Although a larger thickness of the internal porous layer 10b is preferred to reduce the dendrite growth, a smaller thickness is preferred in the application to batteries because the electrical resistance increases with the thickness of the internal porous layer 10b.

According to another preferred embodiment of the present invention, the dendrite buffer layer is (ii) a releasable interfacial layer 10b′ at which two adjacent layers composing part of the LDH-like compound separator are in releasable contact with each other, like the LDH-like compound separator 10′ shown in FIG. 2. In other words, the LDH-like compound separator 10′ of the present embodiment comprises a pair of LDH-like compound separator bodies 10a including the porous substrate and the LDH-like compound, and a releasable interfacial layer 10b′ in releasable contact with the pair of LDH-like compound separator bodies 10a. In the present specification, “two layers are in releasable contact with each other” indicates that the two layers are fully or partially in contact with each other, and the contact area of the two layers can be reduced (e.g., one layer can be at least partially away from the other layer) along with the deposition and growth of zinc dendrites at the interface between the two layers. The LDH-like compound separator bodies 10a may have the same configuration as the conventional LDH-like compound separators as disclosed in Patent Literatures 1 to 3, and thus can exhibit the same preventive advantage to short circuit caused by dendrites as the conventional LDH-like compound separators. However, a further improvement is desired as described above. In the present embodiment, the releasable interfacial layer 10b′ is provided that releasably contacts with the pair of LDH-like compound separator bodies 10a, the zinc dendrites are preferentially deposited and grown on the releasable interfacial layer 10b′, and the deposition and growth of zinc dendrites while expanding the releasable interfacial layer 10b′ are confined only within the releasable interfacial layer 10b′, thereby the penetration of the dendrites through the separator can be prevented or significantly delayed. The LDH-like compound separator 10′ of the present embodiment can be manufactured by stacking a pair of LDH-like compound separator bodies 10a. Furthermore, the stack of the LDH-like compound separator bodies 10a is preferably pressed to densify during or after the stacking process. The press of the stack may be performed by any process, such as roll pressing, uniaxial pressing, and CIP (cold isostatic pressing), preferably roll pressing. The stack may be pressed while being heated to soften the polymeric porous substrate, such that the pores of the porous substrate can be sufficiently filled with the LDH-like compound. The temperature to sufficiently soften the substrate is preferably 60° C. or higher in the case of, for example, polypropylene.

According to another preferred embodiment of the present invention, the dendrite buffer layer is (iii) an inner space layer 10b″ (without the LDH-like compound and the porous substrate), like the LDH-like compound separator 10″ shown in FIG. 3, the inner space layer being formed such that two adjacent layers constituting a part of the LDH-like compound separator are disposed apart from each other. In other words, the LDH-like compound separator 10″ of the present embodiment includes a pair of LDH-like compound separator bodies 10a including the porous substrate and the LDH-like compound, and the inner space layer 10b″ (without the LDH-like compound and the porous substrate) interposed between the pair of LDH-like compound separator bodies 10a. The LDH-like compound separator bodies 10a may have the same configuration as the conventional LDH-like compound separators as disclosed in Patent Literatures 1 to 3, and thus can exhibit the same preventive advantage to short circuit caused by dendrites as the conventional LDH-like compound separators. However, a further improvement is desired as described above. In the present embodiment, the inner space layer 10b″ without the porous substrate and the LDH-like compound is provided between the pair of LDH-like compound separator bodies 10a, zinc dendrites are preferentially deposited and grown in the inner space layer 10b″, and the deposition and growth of zinc dendrites are confined only within the internal porous layer 10b″, thereby the penetration of the dendrites through the separator can be prevented or significantly delayed. The LDH-like compound separator 10″ of the present embodiment can be manufactured by disposing a pair of LDH-like compound separator bodies 10a apart from each other. A spacer may be interposed between the pair of LDH-like compound separator bodies 10a. The spacer desirably has low electrical resistance to avoid to be resistant in the separator. Examples of low-resistance spacers include conductive materials and porous substrates through which an aqueous alkaline solution can flow (i.e., having communication paths across the thickness). Also, the spacer is preferably thinner for the same reason. Each of LDH-like compound separator bodies 10a is preferably pressed to densify prior to disposing as described above. This pressing may be performed by any procedure, such as roll pressing, uniaxial pressure pressing, and CIP (cold isostatic pressing), preferably roll pressing. This pressing preferably involves heating of the composite material to soften the polymeric porous substrate and thereby to sufficiently plug the pores in the porous substrate with the LDH-like compound. For example, the heating temperature required for enough softening is preferably 60° C. or higher in the case that the polymer is polypropylene. The inner space layer 10b″ has a thickness of preferably 1 mm or less, more preferably 0.5 mm or less, further more preferably 0.1 mm or less, particularly more preferably 0.05 mm or less, most preferably 0.01 mm or less. The inner space layer 10b″ has any lower limit of the thickness, because a small space is merely enough for the inner space layer 10b″ and the thickness is preferably as small as possible in the case of incorporation into batteries (in particular, small batteries).

The LDH-like compound separator includes a layered double hydroxide (LDH)-like compound, and can isolate a positive electrode plate from a negative electrode plate and ensures hydroxide ionic conductivity therebetween in a secondary zinc battery. The LDH-like compound separator functions as a hydroxide ionic conductive separator. Preferred LDH-like compound separator has gas-impermeability and/or water-impermeability. In other words, the LDH-like compound separator is preferably densified to an extent that exhibits gas-impermeability and/or water-impermeability. The phrase “having gas-impermeability” throughout the specification indicates that no bubbling of helium gas is observed at one side of a sample when helium gas is brought into contact with the other side in water at a differential pressure of 0.5 atm across the thickness as described in Patent Literatures 2 and 3. In addition, the phrase “having water-impermeability” throughout the specification indicates that water in contact with one side of the sample does not permeate to the other side as described in Patent Literatures 2 and 3. As a result, the LDH-like compound separator having gas-impermeability and/or water-impermeability indicates having high density to an extent that no gas or no water permeates, and not being a porous membrane or any other porous material that has gas-permeability or water-permeability. Accordingly, the LDH-like compound separator can selectively permeate only hydroxide ions due to its hydroxide ionic conductivity, and can serve as a battery separator. The LDH-like compound separator thereby has a physical configuration that prevents penetration of zinc dendrites generated during a charge mode through the separator, resulting in prevention of short circuit between positive and negative electrodes. Since the LDH-like compound separator has hydroxide ionic conductivity, the ionic conductivity allows a necessary amount of hydroxide ions to efficiently move between the positive electrode plate and the negative electrode plate, and thereby charge/discharge reaction can be achieved on the positive electrode plate and the negative electrode plate.

The LDH-like compound separator preferably has a helium permeability per unit area of 3.0 cm/min atm or less, more preferably 2.0 cm/min atm or less, further more preferably 1.0 cm/min atm or less. A separator having a helium permeability of 3.0 cm/min atm or less can remarkably restrain the permeation of Zn (typically, the permeation of zinc ions or zincate ions) in the electrolytic solution. Thus, it is conceivable in principle that the separator of the present embodiment can effectively restrain the growth of zinc dendrites when used in secondary zinc batteries because Zn permeation is significantly suppressed. The helium permeability is measured through the steps of: supplying helium gas to one side of the separator to allow the helium gas to permeate into the separator; and calculating the helium permeability to evaluate the density of the hydroxide ion conductive separator. The helium permeability is calculated from the expression of F/(P×S) where F is the volume of permeated helium gas per unit time, P is the differential pressure applied to the separator when helium gas permeates through, and S is the area of the membrane through which helium gas permeates. Evaluation of the permeability of helium gas in this manner can extremely precisely determine the density. As a result, a high degree of density that does not permeate as much as possible (or permeate only a trace amount) substances other than hydroxide ions (in particular, zinc that causes deposition of dendritic zinc) can be effectively evaluated. Helium gas is suitable for this evaluation because the helium gas has the smallest constitutional unit among various atoms or molecules which can constitute the gas and its reactivity is extremely low. That is, helium does not form a molecule, and helium gas is present in the atomic form. In this respect, since hydrogen gas is present in the molecular form (H₂), atomic helium is smaller than molecular H₂ in a gaseous state. Basically, H₂ gas is combustible and dangerous. By using the helium gas permeability defined by the above expression as an index, the density can be precisely and readily evaluated regardless of differences in sample size and measurement condition. Thus, whether the separator has sufficiently high density suitable for separators of secondary zinc batteries can be evaluated readily, safely and effectively. The helium permeability can be preferably measured in accordance with the procedure shown in Evaluation 5 in Examples described later.

In the LDH-like compound separator of the present invention, the pores (except for the dendrite buffer layer) in the porous substrate are filled with the LDH-like compound, preferably completely filled with the LDH-like compound. Preferably, the LDH-like compound is:
(a) a hydroxide and/or an oxide with a layered crystal structure, containing: Mg; and one or more elements, which include at least Ti, selected from the group consisting of Ti, Y, and Al, or
(b) a hydroxide and/or an oxide with a layered crystal structure, comprising (i) Ti, Y, and optionally Al and/or Mg, and (ii) at least one additive element M selected from the group consisting of In, Bi, Ca, Sr, and Ba, or
(c) a hydroxide and/or an oxide with a layered crystal structure, comprising Mg, Ti, Y, and optionally Al and/or In, wherein in (c) the LDH-like compound is present in a form of a mixture with In(OH)₃.

According to a preferred embodiment (a) of the present invention, the LDH-like compound is a hydroxide and/or an oxide with a layered crystal structure containing: Mg; and one or more elements, which include at least Ti, selected from the group consisting of Ti, Y, and Al. Accordingly, the LDH-like compound is typically a composite hydroxide and/or a composite oxide of Mg, Ti, optionally Y, and optionally Al. The aforementioned elements may be replaced with other elements or ions to the extent that the basic properties of the LDH-like compound are not impaired, but the LDH-like compound is preferably free from Ni. For example, the LDH-like compound may further contain Zn and/or K. This can further improve the ion conductivity of the LDH-like compound separator.

The LDH-like compound can be identified by X-ray diffraction. Specifically, the LDH-like compound separator has a peak that is derived from the LDH-like compound and detected in the range of typically 5° ≤ 2θ ≤ 10°, more typically 7° ≤ 2θ ≤ 10°, when X-ray diffraction is performed on its surface. As described above, an LDH is a substance having an alternating laminated structure in which exchangeable anions and H₂O are present as an interlayer between stacked basic hydroxide layers. In this regard, when the LDH is measured by X-ray diffraction, a peak due to the crystal structure of the LDH (that is, the (003) peak of LDH) is originally detected at a position of 2θ = 11° to 12°. In contrast, when the LDH-like compound is measured by X-ray diffraction, a peak is typically detected in such a range shifted toward the low angle side from the peak position of the LDH. Further, the interlayer distance in the layered crystal structure can be determined by Bragg’s equation using 2θ corresponding to peaks derived from the LDH-like compound in X-ray diffraction. The interlayer distance in the layered crystal structure constituting the LDH-like compound thus determined is typically 0.883 to 1.8 nm, more typically 0.883 to 1.3 nm.

The LDH-like compound separator according to the above embodiment (a) preferably has an atomic ratio Mg/(Mg + Ti + Y + Al) in the LDH-like compound, as determined by energy dispersive X-ray spectroscopy (EDS), of 0.03 to 0.25, more preferably 0.05 to 0.2. Further, an atomic ratio Ti/(Mg + Ti + Y + Al) in the LDH-like compound is preferably 0.40 to 0.97, more preferably 0.47 to 0.94. Further, an atomic ratio Y/(Mg + Ti + Y + Al) in the LDH-like compound is preferably 0 to 0.45, more preferably 0 to 0.37. Further, an atomic ratio Al/(Mg + Ti + Y + Al) in the LDH-like compound is preferably 0 to 0.05, more preferably 0 to 0.03. Within such a range, the alkali resistance is further excellent, and the effect of suppressing short circuits due to zinc dendrites (that is, dendrite resistance) can be achieved more effectively. Meanwhile, LDHs conventionally known for LDH separators can be expressed by a basic composition represented by the formula: M²⁺₁₋ ₓM³⁺ₓ (OH)₂Aⁿ⁻_{x/n}·mH₂O (in the formula, M²⁺ is a divalent cation, M³⁺ is a trivalent cation, Aⁿ⁻ is an n-valent anion, n is an integer of 1 or more, x is 0.1 to 0.4, and m is 0 or more). In contrast, the aforementioned atomic ratios in the LDH-like compound generally deviate from those in the aforementioned formula of LDH. Therefore, it can be said that the LDH-like compound in the present embodiment generally has composition ratios (atomic ratios) different from those of such a conventional LDH. The EDS analysis is preferably performed by 1) capturing an image at an acceleration voltage of 20 kV and a magnification of 5,000 times, 2) performing analysis at three points at intervals of about 5 µm in the point analysis mode, 3) repeating procedures 1) and 2) above once again, and 4) calculating an average of the six points in total, using an EDS analyzer (for example, X-act, manufactured by Oxford Instruments).

According to another embodiment (b), the LDH-like compound may be a hydroxide and/or an oxide with a layered crystal structure containing (i) Ti, Y, and optionally Al and/or Mg, and (ii) an additive element M. Therefore, the LDH-like compound is typically a complex hydroxide and/or a complex oxide with Ti, Y, the additive element M, and optionally Al and optionally Mg. The additive element M is In, Bi, Ca, Sr, Ba, or combinations thereof. The elements described above may be replaced by other elements or ions to the extent that the basic properties of the LDH-like compound are not impaired, and the LDH-like compound is preferably free of Ni.

The LDH-like compound separator according to the above embodiment (b) preferably has an atomic ratio of Ti/(Mg + Al + Ti + Y + M) of 0.50 to 0.85 in the LDH-like compound, as determined by energy dispersive X-ray spectroscopy (EDS) and more preferably has the atomic ratio of 0.56 to 0.81. An atomic ratio of Y/(Mg + Al + Ti + Y + M) in the LDH-like compound is preferably 0.03 to 0.20 and more preferably 0.07 to 0.15. An atomic ratio of M/(Mg + Al + Ti + Y + M) in the LDH-like compound is preferably 0.03 to 0.35 and more preferably 0.03 and 0.32. An atomic ratio of Mg/(Mg + Al + Ti + Y + M) in the LDH-like compound is preferably 0 to 0.10 and more preferably 0 to 0.02. In addition, an atomic ratio of Al/(Mg + Al + Ti + Y + M) in the LDH-like compound is preferably 0 to 0.05 and more preferably 0 to 0.04. The ratios within the above ranges enable to achieve more excellent alkali resistance and a short-circuit inhibition effect caused by zinc dendrite (i.e., dendrite resistance) in more efficient manner. By the way, an LDH that is conventionally known with respect to an LDH separator, can be represented by the basic composition of the formula: M²⁺₁₋ₓM³⁺ₓ(OH)₂Aⁿ⁻_{x/n}·mH₂O wherein M²⁺ is a divalent cation, M³⁺ is a trivalent cation, Aⁿ⁻ is an n-valent anion, n is an integer of 1 or greater, x is 0.1 to 0.4, and m is an integer of to 0 or greater. In contrast, the above atomic ratio in the LDH-like compound generally deviates from that of the above formula of LDH. Therefore, the LDH-like compound in the present embodiment can be generally said to have a composition ratio (atomic ratio) different from that of conventional LDH. The EDS analysis is preferably carried out with an EDS analyzer (for example, X-act manufactured by Oxford Instruments) by 1) capturing an image at an accelerating voltage of 20 kV and a magnification of 5.000 times, 2) carrying out a three-point analysis at about 5 µm intervals in a point analysis mode, 3) repeating the above 1) and 2) once more, and 4) calculating an average value of a total of 6 points.

According to yet another embodiment (c), the LDH-like compound may be a hydroxide and/or an oxide with a layered crystal structure, comprising Mg, Ti, Y, and optionally Al and/or In, in which the LDH-like compound dis present in a form of a mixture with In(OH)₃. The LDH-like compound of the present embodiment is a hydroxide and/or an oxide with a layered crystal structure containing Mg, Ti, Y, and optionally Al and/or In. Therefore, the typical LDH-like compound is a complex hydroxide and/or a complex oxide with Mg, Ti, Y, optionally Al, and optionally In. Here, In that can be contained in the LDH-like compound may be not only one intentionally added, but also one unavoidably incorporated in the LDH-like compound derived from formation of In(OH)₃ or the like. The elements described above may be replaced by other elements or ions to the extent that the basic properties of the LDH-like compound are not impaired, and the LDH-like compound is preferably free of Ni. By the way, an LDH that is conventionally known with respect to an LDH separator, can be represented by the basic composition of the formula: M²⁺₁₋ₓM³⁺ₓ(OH)₂Aⁿ-_{x/n}·mH₂O wherein M²⁺ is a divalent cation, M³⁺ is a trivalent cation, Aⁿ⁻ is an n-valent anion, n is an integer of 1 or greater, x is 0.1 to 0.4, and m is 0 or greater. In contrast, the atomic ratio in the LDH-like compound generally deviates from that of the above formula of LDH. Therefore, the LDH-like compound in the present embodiment can be generally said to have a composition ratio (atomic ratio) different from that of conventional LDH.

The mixture according to the above embodiment (c) contains not only the LDH-like compound but also In(OH)₃ (typically composed of the LDH-like compound and In(OH)₃). In(OH)₃ contained effectively improves alkali resistance and dendrite resistance in the LDH-like compound separator. The content ratio of In(OH)₃ in the mixture is preferably an amount that can improve the alkali resistance and dendrite resistance without impairing hydroxide-ion conductivity of the LDH-like compound separator and is not limited to any particular amount. In(OH)₃ may have a cubic crystal structure and may be in a configuration where the crystals thereof are surrounded by the LDH-like compounds. The In(OH)₃ can be identified by X-ray diffraction; and X-ray diffraction measurement is preferably conducted according to the procedure described in the Example below.

As described above, the LDH-like compound separator comprises the LDH-like compound and the porous substrate (typically consists of the porous substrate and the LDH-like compound), and the LDH-like compound plugs the pores in the porous substrate such that the LDH-like compound separator exhibits hydroxide ionic conductivity and gas-impermeability (thus, so as to serve as an LDH-like compound separator exhibiting hydroxide ionic conductivity). In particular, the LDH-like compound is preferably embedded over the entire thickness of the porous substrate other than the dendrite buffer layer (For example, the LDH-like compound preferably plugs most or all pores inside the porous substrate other than the dendrite buffer layer). The LDH-like compound separator has an overall thickness (a thickness including the dendrite buffer layer) of preferably 5 µm to 5 mm, more preferably 5 µm to 1 mm, further more preferably 5 µm to 0.5 mm, particularly more preferably 5 µm to 0.3 mm.

The porous substrate is composed of a polymeric material. The polymeric porous substrate has the following advantages; (1) high flexibility (hard to crack even if thinned), (2) high porosity, (3) high conductivity (small thickness with high porosity), and (4) good manufacturability and handling ability. The polymeric porous substrate has a further advantage; (5) readily folding and sealing the LDH-like compound separator including the porous substrate composed of the polymeric material based on the advantage (1): high flexibility. Preferred examples of the polymeric material include polystyrene, poly(ether sulfone), polypropylene, epoxy resin, poly(phenylene sulfide), fluorocarbon resin (tetra-fluorinated resin such as PTFE), cellulose, nylon, polyethylene and any combination thereof. More preferred examples include polystyrene, poly(ether sulfone), polypropylene, epoxy resin, poly(phenylene sulfide), fluorocarbon resin (tetra-fluorinated resin such as PTFE), nylon, polyethylene and any combination thereof from the viewpoint of a thermoplastic resin suitable for hot pressing. All the various preferred materials described above have alkali resistance to be resistant to the electrolytic solution of batteries. More preferred polymeric materials are polyolefins, such as polypropylene and polyethylene, most preferred are polypropylene and polyethylene from the viewpoint of excellent hot-water resistance, acid resistance and alkali resistance, and low material cost. A polymeric microporous membrane commercially available can be preferably used as such a polymeric porous substrate.

The dendrite buffer layer may be produced by the process described above, and a portion of the LDH-like compound separator other than the dendrite buffer layer or the LDH-like compound separator body 10a can be produced by any process, preferably with appropriate modification of various conditions in known methods (e.g., see Patent Literatures 1 to 4) for producing the LDH-containing functional layer and the composite material (that is, the LDH separator). For example, an LDH-like compound-containing function layer and a composite material (that is, an LDH-like compound separator) can be produced by (1) preparing a porous substrate, (2) applying a solution containing titania sol (or further containing yttrium sol and/or alumina sol) to the porous substrate, followed by drying, to form a titania-containing layer, (3) immersing the porous substrate in a raw material aqueous solution containing magnesium ions (Mg²⁺) and urea (or further containing yttrium ions (Y³⁺)), and (4) hydrothermally treating the porous substrate in the raw material aqueous solution, to form an LDH-like compound-containing function layer on the porous substrate and/or in the porous substrate. It is considered that the presence of urea in step (3) above generates ammonia in the solution through hydrolysis of urea, to increase the pH value, and coexisting metal ions form a hydroxide and/or an oxide, so that the LDH-like compound can be obtained.

In particular, in the case of producing a composite material (that is, an LDH-like compound separator) in which the porous substrate is composed of a polymer material, and the LDH-like compound is incorporated over the entire thickness direction of the porous substrate, the mixed sol solution is preferably applied to the substrate in step (2) above by a technique that allows the mixed sol solution to penetrate all or most of the inside of the substrate. This allows most or almost all the pores inside the porous substrate to be finally filled with the LDH-like compound. Preferable examples of the application technique include dip coating and filtration coating, particularly preferably dip coating. Adjusting the number of applications such as dip coating enables adjustment of the amount of the mixed sol solution to be applied. The substrate coated with the mixed sol solution by dip coating or the like may be dried and then subjected to steps (3) and (4) above.

When the porous substrate is composed of a polymer material, an LDH-like compound separator obtained by the aforementioned method or the like is preferably pressed. This enables an LDH-like compound separator with further excellent denseness to be obtained. The pressing technique is not specifically limited and may be, for example, roll pressing, uniaxial compression press, CIP (cold isotropic pressing) or the like but is preferably roll pressing. This pressing is preferably performed under heating, since the porous polymer substrate is softened, so that the pores of the porous substrate can be sufficiently filled with the LDH-like compound. For sufficient softening, the heating temperature is preferably 60 to 200° C., for example, in the case of polypropylene or polyethylene. The pressing such as roll pressing within such a temperature range can considerably reduce residual pores in the LDH-like compound separator. As a result, the LDH-like compound separator can be extremely densified, and short circuits due to zinc dendrites can be thus suppressed further effectively. Appropriately adjusting the roll gap and the roll temperature in roll pressing enables the morphology of residual pores to be controlled, thereby enabling an LDH-like compound separator with desired denseness to be obtained.

### Secondary Zinc Batteries

The LDH-like compound separator of the present invention is preferably applied to secondary zinc batteries. According to a preferred embodiment of the present invention, a secondary zinc battery comprising the LDH-like compound separator are provided. A typical secondary zinc battery includes a positive electrode, a negative electrode, and an electrolytic solution, and isolates the positive electrode from the negative electrode with the LDH-like compound separator therebetween. The secondary zinc battery of the present invention may be of any type that includes a zinc negative electrode and an electrolytic solution (typically, an aqueous alkali metal hydroxide solution). Accordingly, examples of the secondary zinc battery include secondary nickel-zinc batteries, secondary silver oxide-zinc batteries, secondary manganese oxide-zinc batteries, secondary zinc-air batteries, and various other secondary alkaline zinc batteries. For example, the secondary zinc battery may preferably be a secondary nickel-zinc battery, the positive electrode of which contains nickel hydroxide and/or nickel oxyhydroxide. Alternatively, the secondary zinc battery may be a secondary zinc-air battery, the positive electrode of which is an air electrode.

### Other Batteries

The LDH-like compound separator of the present invention can be used not only in secondary zinc batteries such as nickel-zinc batteries but also in, for example, nickel-hydrogen batteries. In this case, the LDH-like compound separator serves to block a nitride shuttle (movement of nitrate groups between electrodes), which is a factor of the self-discharging in the battery. The LDH-like compound separator of the present invention can also be applied in, for example, lithium batteries (batteries having a negative electrode composed of lithium metal), lithium ion batteries (batteries having a negative electrode composed of, for example, carbon), or lithium-air batteries.

### EXAMPLES

The invention will be further described in more detail by the following Examples.

### Examples A1 to A8

Examples A1 to A8 shown below are reference examples or comparative examples for LDH separators, but the experimental procedures and results in these examples are generally applicable to LDH-like compound separators as well. The following procedures were used to evaluate the LDH separator produced in these Examples.

### Evaluation 1: Identification of LDH Separator

The crystalline phase of the LDH layer was measured with an X-ray diffractometer (RINT TTR III manufactured by Rigaku Corporation) at a voltage of 50 kV, a current of 300 mA, and a measuring range of 10° to 70° to give an XRD profile. The resultant XRD profile was identified with the diffraction peaks of LDH (hydrotalcite compound) described in JCPDS card NO.35-0964.

### Evaluation 2: Determination of Density

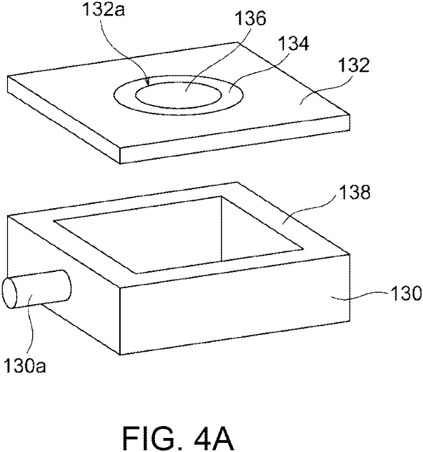

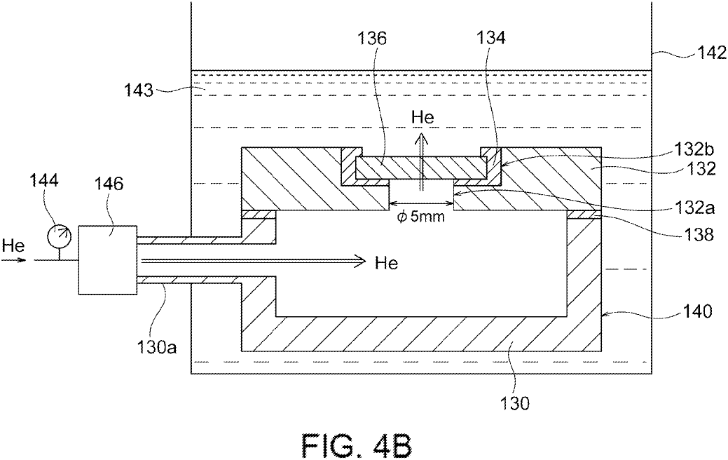

The density was determined to confirm that the LDH separator had density having no gas permeability. As shown in FIGS. 4A and 4B, an open acrylic container 130 and an alumina jig 132 with a shape and dimensions capable of working as a cover of the acrylic container 130 were provided. The acrylic container 130 was provided with a gas supply port 130a. The alumina jig 132 had an opening 132a having a diameter of 5 mm and a cavity 132b surrounding the opening 132a for placing the sample. An epoxy adhesive 134 was applied onto the cavity 132b of the alumina jig 132. The LDH separator was placed into the cavity 132b and was bonded to the alumina jig 132 in an air-tight and liquid-tight manner. The alumina jig 132 with the LDH separator 136 was then bonded to the upper end of the acrylic container 130 in an air-tight and liquid-tight manner with a silicone adhesive 138 to completely seal the open portion of the acrylic container 130. A hermetic container 140 was thereby completed for the measurement. The hermetic container 140 for the measurement was placed in a water vessel 142 and the gas supply port 130a of the acrylic container 130 was connected to a pressure gauge 144 and a flow meter 146 so that helium gas was supplied into the acrylic container 130. Water 143 was poured in the water vessel 142 to completely submerge the hermetic container 140 for the measurement. At this time, the air-tightness and liquid-tightness were sufficiently kept in the interior of the hermetic container 140 for the measurement, and one surface of the LDH separator 136 was exposed to the internal space of the hermetic container 140 for the measurement while the other surface of the LDH separator 136 was in contact with water in the water vessel 142. In this state, helium gas was introduced into the acrylic container 130 of the hermetic container 140 for the measurement through the gas supply port 130a. The pressure gauge 144 and the flow meter 146 were controlled such that the differential pressure between the inside and outside of LDH separator 136 reached 0.5 atm (that is, the pressure applied to one surface of the helium gas is 0.5 atm higher than the water pressure applied to the other surface) to observe whether or not bubbling of helium gas occurred in water from the LDH separator 136. When bubbling of helium gas was not observed, the LDH separator 136 was determined to have high density with no gas permeability.

### Evaluation 3: Observation of Cross-Sectional Microstructure

A cross-sectional polished surface of the LDH separator was prepared with an ion milling system (IM4000, manufactured by Hitachi High-Technologies Corporation). The microstructure on the cross-sectional polished surface was observed at an acceleration voltage of 10 kV, and each view was photographed at magnifications of 500 folds, 1000 folds, 2500 folds, 5000 folds and 10000 folds with a scanning electron microscope (SEM, JSM-6610LV, manufactured by JEOL Ltd.).

### Evaluation 4: Test of Short Circuit Caused by Dendrites

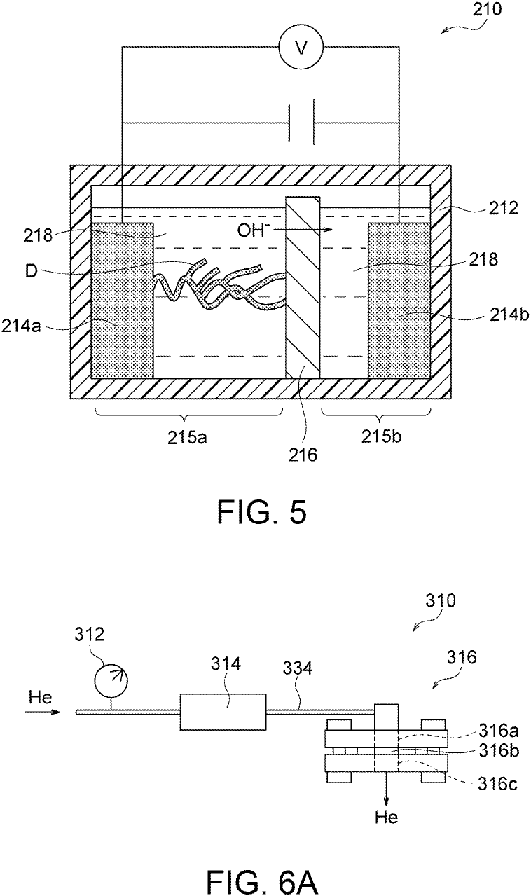

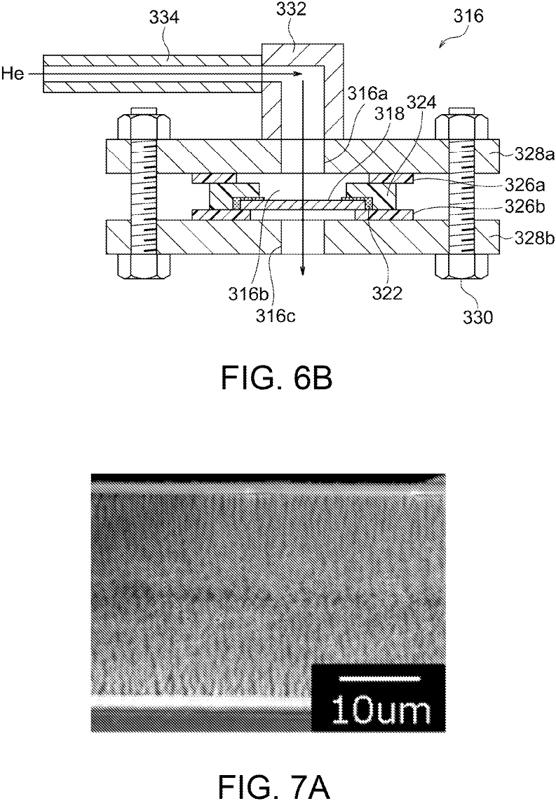

A device 210 was assembled as shown in FIG. 5 and an accelerated test was carried out to continuously grow zinc dendrites. Specifically, a rectangular container 212 made of ABS resin was prepared, in which a zinc electrode 214a is separated by 0.5 cm from a copper electrode 214b to face each other. The zinc electrode 214a is a metal zinc plate, and the copper electrode 214b is a metal copper plate. In addition, an LDH separator structure including the LDH separator 216 was constructed, such that an epoxy resin-based adhesive was applied along the outer periphery of the LDH separator, and the LDH separator was bonded to a jig made of ABS resin having an opening at the center. At this time, the bonded area between the jig and the LDH separator was sufficiently sealed with the adhesive to ensure liquid-tightness. The LDH separator structure was then disposed in the container 212 to isolate a first section 215a including the zinc electrode 214a from a second section 215b including the copper electrode 214b, inhibiting liquid communication other than the area of the LDH separator 216. In this configuration, three outer edges of the LDH separator structure (or three outer edges of the jig made of ABS resin) were bonded to the inner wall of the container 212 with an epoxy resin adhesive to ensure liquid-tightness. In other words, the bonded area between the separator structure including the LDH separator 216 and the container 212 was sealed to inhibit the liquid communication. 5.4 mol/L aqueous KOH solution as an aqueous alkaline solution 218 was poured into the first section 215a and the second section 215b along with ZnO powders equivalent to saturated solubility. The zinc electrode 214a and the copper electrode 214b were connected to a negative terminal and a positive terminal of the constant-current power supply, respectively, and a voltmeter was also connected in parallel with the constant-current power supply. The liquid level of the aqueous alkaline solution 218 was determined below the height of the LDH separator structure (including the jig) such that the entire area of the LDH separator 216 in both the first section 215a and the second section 215b was immersed in the aqueous alkaline solution 218. In the measurement device 210 having such a configuration, a constant current of 20 mA/cm² was continuously applied between the zinc electrode 214a and the copper electrode 214b for up to 200 hours. During application of the constant current, the voltage between the zinc electrode 214a and the copper electrode 214b was monitored with a voltmeter to check for short circuit caused by zinc dendrites (a sharp voltage drop) between the zinc electrode 214a and the copper electrode 214b. No short circuit for over 100 hours was determined as “(short circuit) not found”, and short circuit within less than 100 hours was determined as “(short circuit) found”.

### Evaluation 5: Helium Permeability

A helium permeation test was conducted to evaluate the density of the LDH separator from the viewpoint of helium permeability. The helium permeability measurement system 310 shown in FIGS. 3A and 3B was constructed. The helium permeability measurement system 310 was configured to supply helium gas from a gas cylinder filled with helium gas to a sample holder 316 through the pressure gauge 312 and a flow meter 314 (digital flow meter), and to discharge the gas by permeating from one side to the other side of the LDH separator 318 held by the sample holder 316.

The sample holder 316 had a structure including a gas supply port 316a, a sealed space 316b and a gas discharge port 316c, and was assembled as follows: An adhesive 322 was applied along the outer periphery of the LDH separator 318 and bonded to a jig 324 (made of ABS resin) having a central opening. Gaskets or sealing members 326a, 326b made of butyl rubber were disposed at the upper end and the lower end, respectively, of the jig 324, and then the outer sides of the members 326a, 326b were held with supporting members 328a, 328b (made of PTFE) each including a flange having an opening. Thus, the sealed space 316b was partitioned by the LDH separator 318, the jig 324, the sealing member 326a, and the supporting member 328a. The supporting members 328a and 328b were tightly fastened to each other with fastening means 330 with screws not to cause leakage of helium gas from portions other than the gas discharge port 316c. A gas supply pipe 334 was connected to the gas supply port 316a of the sample holder 316 assembled as above through a joint 332.

Helium gas was then supplied to the helium permeability measurement system 310 via the gas supply pipe 334, and the gas was permeated through the LDH separator 318 held in the sample holder 316. A gas supply pressure and a flow rate were then monitored with a pressure gauge 312 and a flow meter 314. After permeation of helium gas for one to thirty minutes, the helium permeability was calculated. The helium permeability was calculated from the expression of F/(P×S) where F (cm³/min) was the volume of permeated helium gas per unit time, P (atm) was the differential pressure applied to the LDH separator when helium gas permeated through, and S (cm²) was the area of the membrane through which helium gas permeates. The permeation rate F (cm³/min) of helium gas was read directly from the flow meter 314. The gauge pressure read from the pressure gauge 312 was used for the differential pressure P. Helium gas was supplied such that the differential pressure P was within the range of 0.05 to 0.90 atm.

### Example A1 (Reference)

### Preparation of Polymeric Porous Substrate

A commercially available polypropylene porous substrate having a porosity of 60%, a mean pore size of 0.05 µm, and a thickness of 20 µm was cut out into a size of 2.0 cm × 2.0 cm.

### Coating of Alumina/Titania Sol on Polymeric Porous Substrate

An amorphous alumina solution (Al-ML15, manufactured by Taki Chemical Co., Ltd.) and a titanium oxide sol solution (M6, manufactured by Taki Chemical Co., Ltd.) were mixed at Ti/Al molar ratio of 2 to yield a mixed sol. The substrate prepared in Process (1) was immersed in ethanol for one minute, and then immediately transferred into the mixed sol before being dried. The mixed sol was applied onto the substrate by dip coating. In dip coating, the substrate was immersed in 100 mL of the mixed sol, pulled up vertically and dried in a dryer at 90° C. for five minutes.

### Preparation of Aqueous Raw Material Solution

Nickel nitrate hexahydrate (Ni(NO₃)₂·6H₂O, manufactured by Kanto Chemical Co., Inc.), and urea ((NH₂)₂CO, manufactured by Sigma-Aldrich Corporation) were provided as raw materials. Nickel nitrate hexahydrate was weighed to be 0.015 mol/L and placed in a beaker. Ion-exchanged water was added into a total volume of 75 mL. After stirring the solution, the urea weighed at a urea/NO₃⁻ molar ratio of 16 was added, and further stirred to give an aqueous raw material solution.

### Formation of Membrane by Hydrothermal Treatment

The aqueous raw material solution and the dip-coated substrate were encapsulated into a Teflon® autoclave (the internal volume: 100 mL, covered with stainless steel jacket). The substrate was horizontally fixed away from the bottom of the Teflon® autoclave such that the solution was in contact with the two surfaces of the substrate. An LDH was then formed on the surface and the interior of the substrate by a hydrothermal treatment at a temperature of 120° C. for 24 hour. After a predetermined period, the substrate was removed from the autoclave, washed with ion-exchanged water, and dried at 70° C. for ten hours to form the LDH in the pores of porous substrate and give the LDH separator.

### Results of Evaluation

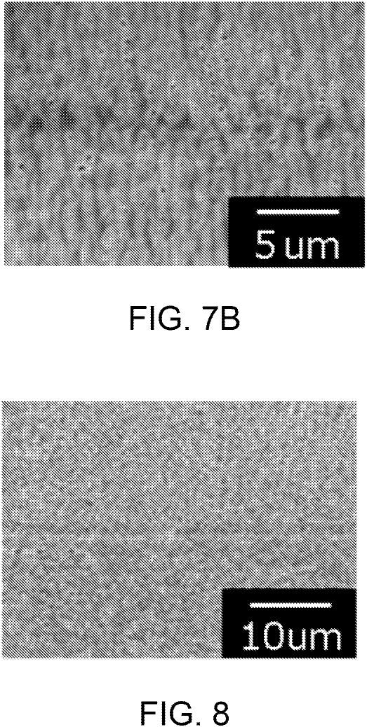

The resultant LDH separator was evaluated in accordance with Evaluations 1 to 5. As a result of Evaluation 1, this LDH separator was identified as LDH (hydrotalcite compound). As a result of Evaluation 2, bubbling of helium gas was not observed in this LDH separator. Evaluation 3, as shown in FIGS. 7A and 7B, indicated that this LDH separator had an internal porous layer being free from or deficient in the LDH between a pair of LDH separator bodies. The results of Evaluations 4 and 5 are shown in Table 1.

### Example A2 (Reference)

An LDH separator layer including no internal porous layer was produced as in Example A1 except that the mixed sol was applied onto the substrate by dip coating without immersion in ethanol in Process (2). Two sheets of the LDH separator layer produced as above were stacked. The stack was disposed between a pair of PET films (Lumirror® manufactured by Toray Industries, Inc., a thickness of 40 µm), and roll-pressed at a rotation rate of 3 mm/s, at a roller temperature of 100° C., and with a gap between rollers of 150 µm to give an LDH separator including a releasable interfacial layer. The resultant LDH separator was evaluated as in Example A1. As a result of Evaluation 1, this LDH separator was identified as LDH (hydrotalcite compound). As a result of Evaluation 2, bubbling of helium gas was not observed in this LDH separator. Evaluation 3, as shown in FIG. 8, indicated that this LDH separator had a releasable interfacial layer between a pair of LDH separator bodies, thereby the two LDH separator bodies were in releasable contact with each other. The results of Evaluations 4 and 5 are shown in Table 1. FIG. 10 illustrates a cross-sectional SEM image of the LDH separator photographed after the test of short circuit caused by dendrites in Evaluation 4, where the symbol D indicates a dendrite in the image.

### Example A3 (Reference)

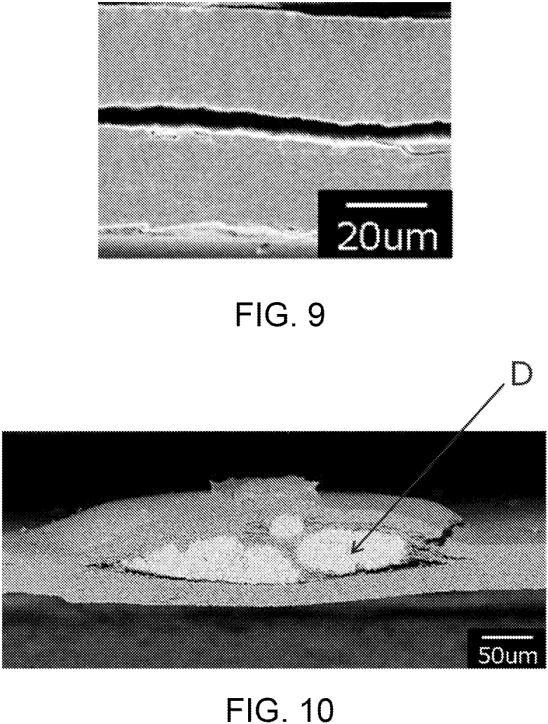

An LDH separator layer including no internal porous layer was produced as in Example A1 except that the mixed sol was applied onto the substrate by dip coating without immersion in ethanol in Process (2). Two sheets of the LDH separator layer produced as above were disposed to face each other with a gap of about 5 µm to give an LDH separator including an internal gap layer. The resultant LDH separator was evaluated as in Example A1. As a result of Evaluation 1, this LDH separator was identified as LDH (hydrotalcite compound). As a result of Evaluation 2, bubbling of helium gas was not observed in this LDH separator. Evaluation 3, as shown in FIG. 9, indicates that this LDH separator had an internal gap layer between a pair of LDH separator bodies. The internal gap layer was free from the LDH and the porous substrate between two LDH separator bodies. The results of Evaluations 4 and 5 are shown in Table 1.

### Example A4 (Comparative)

An LDH separator layer including no internal porous layer was produced as in Example A1 except that the mixed sol was applied onto the substrate by dip coating without immersion in ethanol in Process (2). The resultant LDH separator was evaluated as in Example A1. As a result of Evaluation 1, this LDH separator is identified as LDH (hydrotalcite compound). As a result of Evaluation 2, bubbling of helium gas was not observed in this LDH separator. Evaluation 3 indicated that this LDH separator was composed only of a single LDH layer, and no dendrite buffer layer was found. The results of Evaluations 4 and 5 are shown in Table 1.

### Example A5 (Reference)

An LDH separator was produced and evaluated as in Example A1 except for the following conditions a) to c).

a) A commercially available polyethylene porous substrate having a porosity of 40%, a mean pore size of 0.05 µm and a thickness of 20 µm was used for the polymeric porous substrate in Process (1).

b) Magnesium nitrate hexahydrate (Mg(NO₃)_{2′}6H₂O, manufactured by Kanto Chemical Co., Ltd.) was used instead of the nickel nitrate hexahydrate in Process (3), weighed to be 0.03 mol/L, and placed in a beaker. Ion-exchanged water was added into a total volume of 75 mL. After stirring the resultant solution, the urea weighed at a urea/NO₃⁻ molar ratio of 8 was added, and further stirred to give an aqueous raw material solution.

c) The hydrothermal temperature in Process (4) was 90° C.

As a result of Evaluation 1, this LDH separator was identified as LDH (hydrotalcite compound). As a result of Evaluation 2, bubbling of helium gas was not observed in this LDH separator. Evaluation 3 indicated that this LDH separator had an internal porous layer being free from or deficient in the LDH between a pair of LDH separator bodies, similar to Example A1. The results of Evaluations 4 and 5 are shown in Table 1.

### Example A6 (Reference)

An LDH separator layer including no internal porous layer was produced as in Example A1 except for the following conditions a) to d).

a) A commercially available polyethylene porous substrate having a porosity of 40%, a mean pore size of 0.05 µm and a thickness of 20 µm was used for the polymeric porous substrate in Process (1).

b) The mixed sol was applied onto the substrate by dip coating without immersion in ethanol in Process (2).

c) Magnesium nitrate hexahydrate (Mg(NO₃)₂·6H₂O, manufactured by Kanto Chemical Co., Ltd.) was used instead of the nickel nitrate hexahydrate in Process (3), weighed to be 0.03 mol/L, and placed in a beaker. Ion-exchanged water was added into a total volume of 75 mL. After stirring the resultant solution, the urea weighed at a urea/NO₃⁻ molar ratio of 8 was added, and further stirred to give an aqueous raw material solution.

d) The hydrothermal temperature in Process (4) was 90° C.

Two sheets of the LDH separator layer produced as above was stacked. The stack was disposed between a pair of PET films (Lumirror® manufactured by Toray Industries, Inc., a thickness of 40 µm), and roll-pressed at a rotation rate of 3 mm/s, at a roller temperature of 100° C., and with a gap between rollers of 150 µm to give an LDH separator including a releasable interfacial layer. The resultant LDH separator was evaluated as in Example A1. As a result of Evaluation 1, this LDH separator was identified as LDH (hydrotalcite compound). As a result of Evaluation 2, bubbling of helium gas was not observed in this LDH separator. Evaluation 3 indicated this LDH separator had the releasable interfacial layer, between a pair of LDH separator bodies, thereby two LDH separator bodies were in releasable contact with each other, similar to Example A2. The results of Evaluations 4 and 5 are shown in Table 1.

### Example A7 (Reference)

An LDH separator layer including no internal porous layer was produced as in Example A1 except for the following conditions a) to d).

a) A commercially available polyethylene porous substrate having a porosity of 40%, a mean pore size of 0.05 µm and a thickness of 20 µm was used for the polymeric porous substrate in Process (1).

b) The mixed sol was applied onto the substrate by dip coating without the immersion in ethanol in Process (2).

c) Magnesium nitrate hexahydrate (Mg(NO₃)₂·6H₂O, manufactured by Kanto Chemical Co., Ltd.) was used instead of the nickel nitrate hexahydrate in Process (3), weighed to be 0.03 mol/L, and placed in a beaker. Ion-exchanged water was added into a total volume of 75 mL. After stirring the resultant solution, the urea weighed at a urea/NO₃⁻ molar ratio of 8 was added, and further stirred to give an aqueous raw material solution.

d) The hydrothermal temperature in Process (4) was 90° C.

Two sheets of the LDH separator layer produced as above were disposed to face each other with a gap of about 5 µm to give an LDH separator including an internal gap layer as a whole. The resultant LDH separator was evaluated as in Example A1. As a result of Evaluation 1, this LDH separator was identified as LDH (hydrotalcite compound). As a result of Evaluation 2, bubbling of helium gas was not observed in this LDH separator. Evaluation 3 indicated that this LDH separator had, between a pair of LDH separator bodies, the internal gap layer being free from the LDH and the porous substrate, similarly to Example A3. The results of Evaluations 4 and 5 are shown in Table 1.

### Example A8 (Comparative)

An LDH separator layer including no internal porous layer was produced as in Example A1 except for the following conditions a) to c).

a) A commercially available polyethylene porous substrate having a porosity of 40%, a mean pore size of 0.05 µm and a thickness of 20 µm was used for the polymeric porous substrate in Process (1).

b) The mixed sol was applied onto the substrate by dip coating without immersion in ethanol in Process (2).

c) Magnesium nitrate hexahydrate (Mg(NO₃)₂·6H₂O, manufactured by Kanto Chemical Co., Ltd.) was used instead of the nickel nitrate hexahydrate in Process (3), weighed to be 0.03 mol/L, and placed in a beaker. Ion-exchanged water was added into a total volume of 75 mL. After stirring the resultant solution, the urea weighed at a urea/NO₃⁻ molar ratio of 8 was added, and further stirred to give an aqueous raw material solution.

d) The hydrothermal temperature in Process (4) was 90° C.

As a result of Evaluation 1, this LDH separator was identified as LDH (hydrotalcite compound). As a result of Evaluation 2, bubbling of helium gas was not observed in this LDH separator. Evaluation 3 indicated that this LDH separator was composed only of a single LDH layer, and no dendrite buffer layer was found. The results of Evaluations 4 and 5 are shown in Table 1.

[Table 1]

TABLE 1

| | Dendrite buffer layer | Types of dendrite buffer layer | Evaluations | |
|---|---|---|---|---|
| | | | Helium permeability (cm/atm -min) | Short circuit cause by dendrites |
| Example A1^{#} | With | Internal porous layer | 0.1 | Not found |
| Example A2^{#} | With | Releasable interfacial layer | 0 | Not found |
| Example A3^{#} | With | Internal gap layer | 0 | Not found |
| Example A4* | Without | - | 0.1 | Found |
| Example A5^{#} | With | Internal porous layer | 0 | Not found |
| Example A6^{#} | With | Releasable interfacial layer | 0 | Not found |
| Example A7^{#} | With | Internal gap layer | 0 | Not found |
| Example A8* | Without | - | 0.1 | Found |

Symbol ^{#} represents a reference example.
Symbol * represents a comparative example.

### Examples B1 to B8

Examples B1 to B7 shown below are reference examples for LDH-like compound separators, while Examples B8 shown below is a comparative example for an LDH separator. The LDH-like compound separators and LDH separator will be collectively referred to as hydroxide ion-conductive separators. The method for evaluating the hydroxide ion-conductive separators produced in the following examples was as follows.

### Evaluation 1: Observation of Surface Microstructure

The surface microstructure of the hydroxide ion-conductive separator was observed using a scanning electron microscope (SEM, JSM-6610LV, manufactured by JEOL Ltd.) at an acceleration voltage of 10 to 20 kV.

### Evaluation 2: STEM Analysis of Layered Structure

The layered structure of the hydroxide ion-conductive separator was observed using a scanning transmission electron microscope (STEM) (product name: JEM-ARM200F, manufactured by JEOL Ltd.) at an acceleration voltage of 200 kV.

### Evaluation 3: Elemental Analysis Evaluation (EDS)

A surface of the hydroxide ion-conductive separator was subjected to compositional analysis using an EDS analyzer (device name: X-act, manufactured by Oxford Instruments), to calculate the composition ratio (atomic ratio) Mg:Ti:Y:Al. This analysis was performed by 1) capturing an image at an acceleration voltage of 20 kV and a magnification of 5,000 times, 2) performing analysis at three points at intervals of about 5 µm in the point analysis mode, 3) repeating procedures 1) and 2) above once again, and 4) calculating an average of the six points in total.

### Evaluation 4: X-Ray Diffraction Measurement

Using an X-ray diffractometer (RINT TTR III, manufactured by Rigaku Corporation), the crystalline phase of the hydroxide ion-conductive separator was measured under the measurement conditions of voltage: 50 kV, current value: 300 mA, and measurement range: 5 to 40°, to obtain an XRD profile. Further, the interlayer distance in the layered crystal structure was determined by Bragg’s equation using 2θ corresponding to peaks derived from the LDH-like compound.

### Evaluation 5: He Permeation Measurement

In order to evaluate the denseness of the hydroxide ion-conductive separator in view of the He permeation, a He permeation test was performed in the same procedure as in Evaluation 5 of Examples A1 to A15.

### Evaluation 6: Measurement of Ion Conductivity

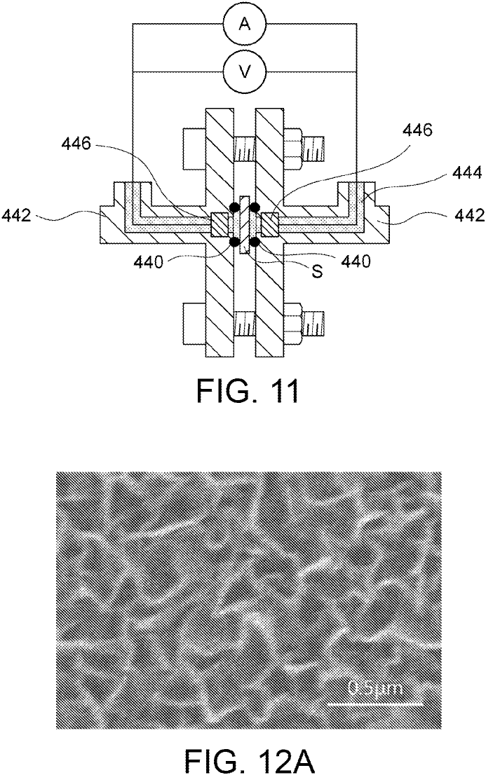

The conductivity of the hydroxide ion-conductive separator in the electrolytic solution was measured using the electrochemical measurement system shown in FIG. 11, as follows. A hydroxide ion-conductive separator sample S was sandwiched by 1-mm thick silicone packings 440 from both sides, to be assembled in a PTFE flange-type cell 442 with an inner diameter of 6 mm. As electrodes 446, nickel wire meshes of #100 mesh were assembled in the cell 442 into a cylindrical shape with a diameter of 6 mm, so that the distance between the electrodes was 2.2 mm. The cell 442 was filled with a 5.4 M KOH aqueous solution as an electrolytic solution 444. Using electrochemical measurement systems (potentiostat/galvanostat-frequency response analyzers Type 1287A and Type 1255B, manufactured by Solartron Metrology), measurement was performed under the conditions of a frequency range of 1 MHz to 0.1 Hz and an applied voltage of 10 mV, and the real axis intercept was taken as the resistance of the hydroxide ion conductive separator sample S. The same measurement as above was carried out without the hydroxide ion-conductive separator sample S, to determine a blank resistance. The difference between the resistance of the hydroxide ion-conductive separator sample S and the blank resistance was taken as the resistance of the hydroxide ion-conductive separator. The conductivity was determined using the resistance of the hydroxide ion-conductive separator obtained, and the thickness and area of the hydroxide ion-conductive separator.

### Evaluation 7: Evaluation of Alkali Resistance

A 5.4 M KOH aqueous solution containing zinc oxide at a concentration of 0.4 M was prepared. 0.5 mL of the KOH aqueous solution prepared and a hydroxide ion-conductive separator sample with a size of 2 cm square were put into a closed container made of Teflon®. Thereafter, it was maintained at 90° C. for one week (that is, 168 hours), and then the hydroxide ion-conductive separator sample was taken out of the closed container. The hydroxide ion-conductive separator sample taken out was dried overnight at room temperature. For the sample obtained, the He permeability was calculated in the same manner as in Evaluation 5, to determine whether or not the He permeability changed before and after the immersion in alkali.

### Evaluation 8: Evaluation of Dendrite Resistance (Cycle Test)

In order to evaluate the effect of suppressing short circuits due to zinc dendrites (dendrite resistance) of the hydroxide ion-conductive separator, a cycle test was performed, as follows. First, each of the positive electrode (containing nickel hydroxide and/or nickel oxyhydroxide) and the negative electrode (containing zinc and/or zinc oxide) was wrapped with a non-woven fabric, and the current extraction terminal was welded thereto. The positive electrode and the negative electrode thus prepared were opposed to each other via the hydroxide ion-conductive separator and sandwiched between laminate films provided with current outlets, and three sides of the laminate films were heat-sealed. An electrolytic solution (a solution in which 0.4 M zinc oxide was dissolved in a 5.4 M KOH aqueous solution) was added to the cell container with the top open thus obtained, and the positive electrode and the negative electrode was sufficiently impregnated with the electrolytic solution by vacuuming or the like. Thereafter, the remaining one side of the laminate films was heat-sealed, to form a simple sealed cell. Using a charge/discharge device (TOSCAT3100, manufactured by TOYO SYSTEM CO., LTD.), the simple sealed cell was charged at 0.1 C and discharged at 0.2 C for chemical conversion. Thereafter, a 1-C charge/discharge cycle was conducted. While repeating the charge/discharge cycle under the same conditions, the voltage between the positive electrode and the negative electrode was monitored with a voltmeter, and the presence or absence of sudden voltage drops (specifically, voltage drops of 5 mV or more from the voltage that was just previously plotted) following short circuits due to zinc dendrites between the positive electrode and the negative electrode was examined and evaluated according to the following criteria.
No short circuits occurred: No sudden voltage drops as described above were observed during charging even after 300 cycles.
Short circuits occurred: Sudden voltage drops as described above were observed during charging in less than 300 cycles.

### Example B1 (Reference)

### Preparation of Porous Polymer Substrate

A commercially available polyethylene microporous membrane with a porosity of 50%, a mean pore size of 0.1 µm, and a thickness of 20 µm was prepared as a porous polymer substrate and cut out into a size of 2.0 cm × 2.0 cm.

### Titania Sol Coating on Porous Polymer Substrate

The substrate prepared by procedure (1) above was coated with a titanium oxide sol solution (M6, manufactured by Taki Chemical Co., Ltd.) by dip coating. Dip coating was performed by immersing the substrate in 100 ml of the sol solution and pulling it out perpendicularly, followed by drying at room temperature for 3 hours.

### Production of Raw Material Aqueous Solution

As raw materials, magnesium nitrate hexahydrate (Mg(NO₃)₂·6H₂O, manufactured by KANTO CHEMICAL CO., INC.) and urea ((NH₂)₂CO, manufactured by Sigma-Aldrich Corporation) were prepared. The magnesium nitrate hexahydrate was weighed to 0.015 mol/L and put into a beaker, and deionized water was added thereto so that the total amount was 75 ml. After stirring the solution obtained, urea weighed at a ratio urea/NO₃⁻ (molar ratio) of 48 was added into the solution, followed by further stirring, to obtain a raw material aqueous solution.

### Membrane Formation by Hydrothermal Treatment

The raw material aqueous solution and the dip-coated substrate were enclosed together in a closed container made of Teflon® (autoclave container, content: 100 ml, with an outer stainless steel jacket). At this time, the substrate was lifted from the bottom of the closed container made of Teflon® and fixed and installed vertically so that the solution was in contact with both sides of the substrate. Thereafter, an LDH-like compound was formed on the surface and inside the substrate by applying hydrothermal treatment at a hydrothermal temperature of 120° C. for 24 hours. After a lapse of a predetermined time, the substrate was taken out of the closed container, washed with deionized water, and dried at 70° C. for 10 hours, to form an LDH-like compound in the pores of the porous substrate. Thus, an LDH-like compound separator was obtained.

### Densification by Roll Pressing

The LDH-like compound separator was sandwiched by a pair of PET films (Lumirror®, manufactured by Toray Industries, Inc., with a thickness of 40 µm) and roll-pressed at a roll rotation speed of 3 mm/s and a roller heating temperature of 70° C. with a roll gap of 70 µm, to obtain an LDH-like compound separator that was further densified.

### Evaluation Results

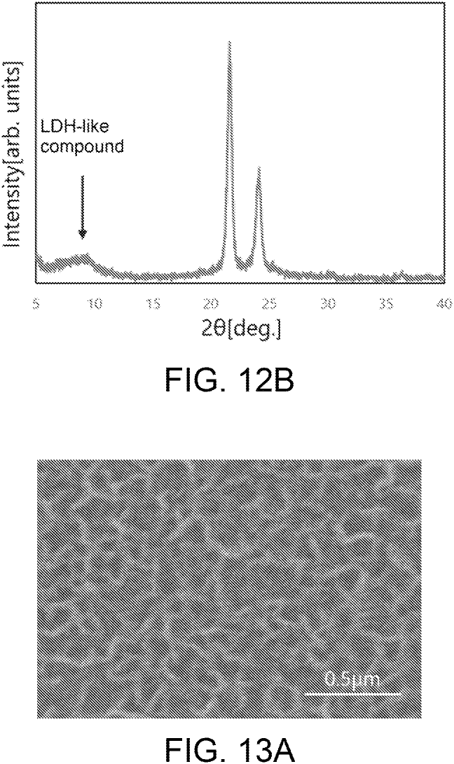

The LDH-like compound separator obtained was subjected to Evaluations 1 to 8. The results were as follows.
Evaluation 1: The SEM image of the surface microstructure of the LDH-like compound separator obtained in Example B1 (before roll pressing) was as shown in FIG. 12A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg and Ti, which were constituent elements of the LDH-like compound, were detected on the surface of the LDH-like compound separator. Further, the composition ratio (atomic ratio) of Mg and Ti on the surface of the LDH-like compound separator, which was calculated by EDS elemental analysis, was as shown in Table 1.
Evaluation 4: FIG. 12B shows the XRD profile obtained in Example B1. In the XRD profile obtained, a peak was observed around 2θ = 9.4°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2 θ° < 25 in the XRD profile are peaks derived from polyethylene constituting the porous substrate. Further, the interlayer distance in the layered crystal structure of the LDH-like compound was 0.94 nm.
Evaluation 5: As shown in Table 2, it was confirmed that the He permeability was 0.0 cm/min·atm, indicating that the denseness was extremely high.
Evaluation 6: As shown in Table 2, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 2, it was confirmed that short circuits due to zinc dendrites did not occur even after 300 cycles, indicating that the dendrite resistance was excellent.

### Example B2 (Reference)

An LDH-like compound separator was produced and evaluated in the same manner as in Example B1 except that the raw material aqueous solution was produced as follows in procedure (3) above, and the temperature for the hydrothermal treatment was changed to 90° C. in procedure (4) above.

### Production of Raw Material Aqueous Solution

As raw materials, magnesium nitrate hexahydrate (Mg(NO₃)₂·6H₂O, manufactured by KANTO CHEMICAL CO., INC.) and urea ((NH₂)₂CO, manufactured by Sigma-Aldrich Corporation) were prepared. The magnesium nitrate hexahydrate was weighed to 0.03 mol/L and put into a beaker, and deionized water was added thereto so that the total amount was 75 ml. After stirring the solution obtained, urea weighed at a ratio urea/NO₃⁻ (molar ratio) of 8 was added into the solution, followed by further stirring, to obtain a raw material aqueous solution.

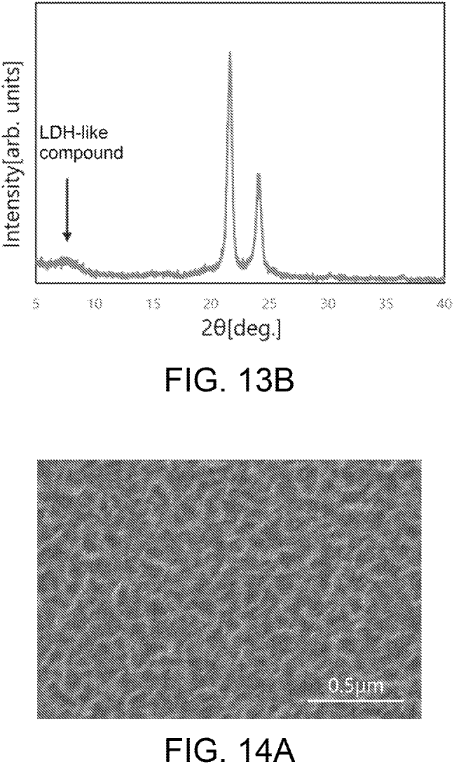

Evaluation 1: The SEM image of the surface microstructure of the LDH-like compound separator obtained in Example B2 (before roll pressing) was as shown in FIG. 13A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg and Ti, which were constituent elements of the LDH-like compound, were detected on the surface of the LDH-like compound separator. Further, the composition ratio (atomic ratio) of Mg and Ti on the surface of the LDH-like compound separator, which was calculated by EDS elemental analysis, was as shown in Table 2.
Evaluation 4: FIG. 13B shows the XRD profile obtained in Example B2. In the XRD profile obtained, a peak was observed around 2θ = 7.2°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2 θ° < 25 in the XRD profile are peaks derived from polyethylene constituting the porous substrate. Further, the interlayer distance in the layered crystal structure of the LDH-like compound was 1.2 nm.
Evaluation 5: As shown in Table 2, it was confirmed that the He permeability was 0.0 cm/min·atm, indicating that the denseness was extremely high.
Evaluation 6: As shown in Table 2, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 2, it was confirmed that short circuits due to zinc dendrites did not occur even after 300 cycles, indicating that the dendrite resistance was excellent.

### Example B3 (Reference)

An LDH-like compound separator was produced and evaluated in the same manner as in Example B1 except that the porous polymer substrate was coated with titania and yttria sols as follows, instead of procedure (2) above.

### Titania-Yttria Sol Coating on Porous Polymer Substrate

A titanium oxide sol solution (M6, manufactured by Taki Chemical Co., Ltd.) and a yttrium sol were mixed at a molar ratio Ti/Y of 4. The substrate prepared in procedure (1) above was coated with the mixed solution obtained by dip coating. Dip coating was performed by immersing the substrate in 100 ml of the mixed solution and pulling it out perpendicularly, followed by drying at room temperature for 3 hours.

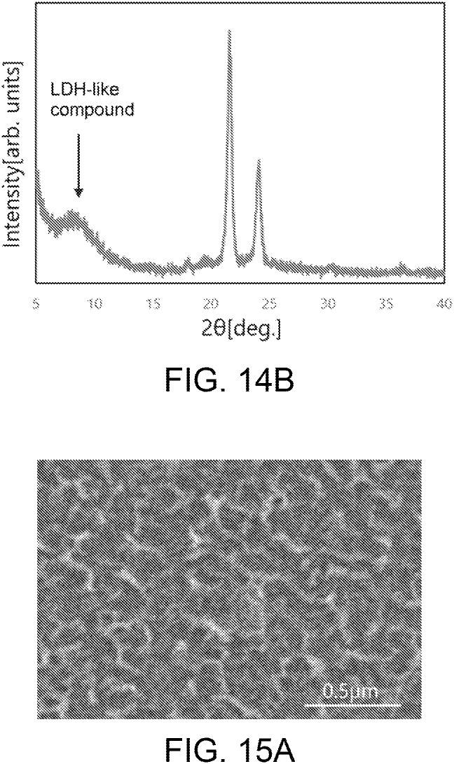

Evaluation 1: The SEM image of the surface microstructure of the LDH-like compound separator obtained in Example B3 (before roll pressing) was as shown in FIG. 14A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg, Ti, and Y, which were constituent elements of the LDH-like compound, were detected on the surface of the LDH-like compound separator. Further, the composition ratio (atomic ratio) of Mg, Ti, and Y on the surface of the LDH-like compound separator, which was calculated by EDS elemental analysis, was as shown in Table 2.
Evaluation 4: FIG. 14B shows the XRD profile obtained in Example B3. In the XRD profile obtained, a peak was observed around 2θ = 8.0°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2 θ° < 25 in the XRD profile are peaks derived from polyethylene constituting the porous substrate. Further, the interlayer distance in the layered crystal structure of the LDH-like compound was 1.1 nm.
Evaluation 5: As shown in Table 2, it was confirmed that the He permeability was 0.0 cm/min·atm, indicating that the denseness was extremely high.
Evaluation 6: As shown in Table 2, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 2, it was confirmed that short circuits due to zinc dendrites did not occur even after 300 cycles, indicating that the dendrite resistance was excellent.

### Example B4 (Reference)

An LDH-like compound separator was produced and evaluated in the same manner as in Example B1 except that the porous polymer substrate was coated with titania, yttria, and alumina sols as follows, instead of procedure (2) above.

### Titania-Yttria-Alumina Sol Coating on Porous Polymer Substrate

A titanium oxide sol solution (M6, manufactured by Taki Chemical Co., Ltd.), a yttrium sol, and an amorphous alumina solution (Al-ML15, manufactured by Taki Chemical Co., Ltd.) were mixed at a molar ratio Ti/(Y + Al) of 2 and a molar ratio Y/Al of 8. The substrate prepared in procedure (1) above was coated with the mixed solution by dip coating. Dip coating was performed by immersing the substrate in 100 ml of the mixed solution and pulling it out perpendicularly, followed by drying at room temperature for 3 hours.

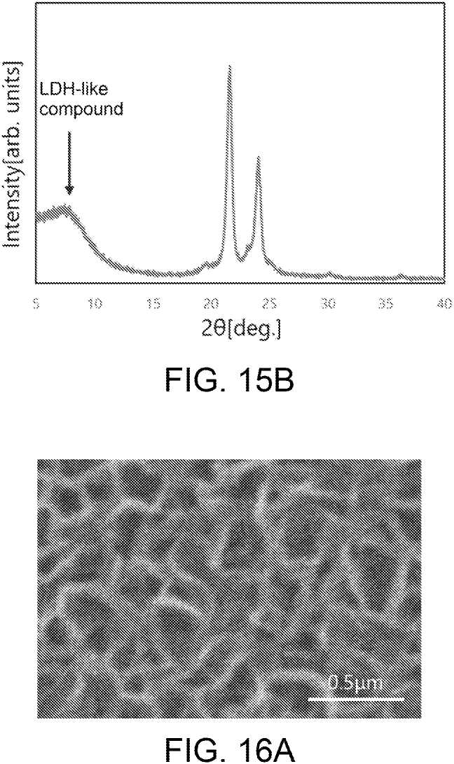

Evaluation 1: The SEM image of the surface microstructure of the LDH-like compound separator obtained in Example B4 (before roll pressing) was as shown in FIG. 15A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg, Al, Ti, and Y, which were constituent elements of the LDH-like compound, were detected on the surface of the LDH-like compound separator. Further, the composition ratio (atomic ratio) of Mg, Al, Ti, and Y on the surface of the LDH-like compound separator, which was calculated by EDS elemental analysis, was as shown in Table 2.
Evaluation 4: FIG. 15B shows the XRD profile obtained in Example B4. In the XRD profile obtained, a peak was observed around 2θ = 7.8°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2θ° < 25 in the XRD profile are peaks derived from polyethylene constituting the porous substrate. Further, the interlayer distance in the layered crystal structure of the LDH-like compound was 1.1 nm.
Evaluation 5: As shown in Table 2, it was confirmed that the He permeability was 0.0 cm/min·atm, indicating that the denseness was extremely high.
Evaluation 6: As shown in Table 2, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 2, it was confirmed that short circuits due to zinc dendrites did not occur even after 300 cycles, indicating that the dendrite resistance was excellent.

### Example B5 (Reference)

An LDH-like compound separator was produced and evaluated in the same manner as in Example B1 except that the porous polymer substrate was coated with titania and yttria sols as follows, instead of procedure (2) above, and the raw material aqueous solution was produced as follows in procedure (3) above.

### Titania-Yttria Sol Coating on Porous Polymer Substrate

A titanium oxide sol solution (M6, manufactured by Taki Chemical Co., Ltd.) and a yttrium sol were mixed at a molar ratio Ti/Y of 18. The substrate prepared in procedure (1) above was coated with the mixed solution obtained by dip coating. Dip coating was performed by immersing the substrate in 100 ml of the mixed solution and pulling it out perpendicularly, followed by drying at room temperature for 3 hours.

### Production of Raw Material Aqueous Solution

As raw materials, magnesium nitrate hexahydrate (Mg(NO₃)₂·6H₂O, manufactured by KANTO CHEMICAL CO., INC.) and urea ((NH₂)₂CO, manufactured by Sigma-Aldrich Corporation) were prepared. The magnesium nitrate hexahydrate was weighed to 0.0075 mol/L and put into a beaker, and deionized water was added thereto so that the total amount was 75 ml. Then, the solution obtained was stirred. Urea weighed at a ratio urea/NO₃⁻ (molar ratio) = 96 was added into the solution, followed by further stirring, to obtain a raw material aqueous solution.

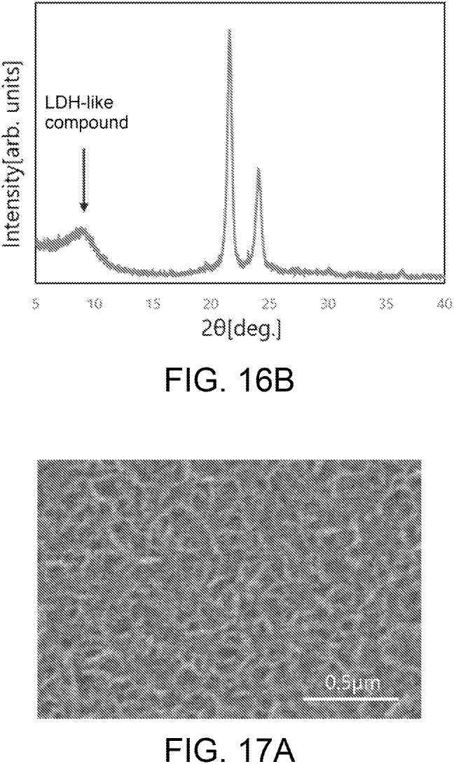

Evaluation 1: The SEM image of the surface microstructure of the LDH-like compound separator obtained in Example B5 (before roll pressing) was as shown in FIG. 16A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg, Ti, and Y, which were constituent elements of the LDH-like compound, were detected on the surface of the LDH-like compound separator. Further, the composition ratio (atomic ratio) of Mg, Ti, and Y on the surface of the LDH-like compound separator, which was calculated by EDS elemental analysis, was as shown in Table 2.
Evaluation 4: FIG. 16B shows the XRD profile obtained in Example B5. In the XRD profile obtained, a peak was observed around 2θ = 8.9°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2 θ° < 25 in the XRD profile are peaks derived from polyethylene constituting the porous substrate. Further, the interlayer distance in the layered crystal structure of the LDH-like compound was 0.99 nm.
Evaluation 5: As shown in Table 2, it was confirmed that the He permeability was 0.0 cm/min·atm, indicating that the denseness was extremely high.
Evaluation 6: As shown in Table 2, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 2, it was confirmed that short circuits due to zinc dendrites did not occur even after 300 cycles, indicating that the dendrite resistance was excellent.

### Example B6 (Reference)

An LDH-like compound separator was produced and evaluated in the same manner as in Example B1 except that the porous polymer substrate was coated with titania and alumina sols as follows, instead of procedure (2) above, and the raw material aqueous solution was produced as follows in procedure (3) above.

### Titania-Alumina Sol Coating on Porous Polymer Substrate

A titanium oxide sol solution (M6, manufactured by Taki Chemical Co., Ltd.) and an amorphous alumina solution (Al-ML15, manufactured by Taki Chemical Co., Ltd.) were mixed at a molar ratio Ti/Al of 18. The substrate prepared in procedure (1) above was coated with the mixed solution by dip coating. Dip coating was performed by immersing the substrate in 100 ml of the mixed solution and pulling it out perpendicularly, followed by drying at room temperature for 3 hours.

### Production of Raw Material Aqueous Solution

As raw materials, magnesium nitrate hexahydrate (Mg(NO₃)₂·6H₂O, manufactured by KANTO CHEMICAL CO., INC.), yttrium nitrate n hydrate (Y(NO₃)₃·nH₂O, manufactured by FUJIFILM Wako Pure Chemical Corporation), and urea ((NH₂)₂CO, manufactured by Sigma-Aldrich Corporation) were prepared. The magnesium nitrate hexahydrate was weighed to 0.0015 mol/L and put into a beaker. Further, the yttrium nitrate n hydrate was weighed to 0.0075 mol/L and put into the beaker, and deionized water was added thereto so that the total amount was 75 ml. Then, the solution obtained was stirred. Urea weighed at a ratio urea/NO₃⁻ (molar ratio) of 9.8 was added into the solution, followed by further stirring, to obtain a raw material aqueous solution.

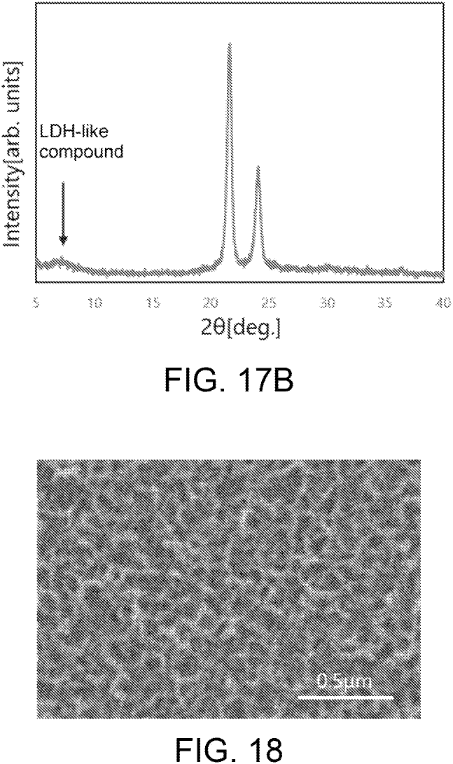

Evaluation 1: The SEM image of the surface microstructure of the LDH-like compound separator obtained in Example B6 (before roll pressing) was as shown in FIG. 17A.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg, Al, Ti, and Y, which were constituent elements of the LDH-like compound, were detected on the surface of the LDH-like compound separator. Further, the composition ratio (atomic ratio) of Mg, Al, Ti, and Y on the surface of the LDH-like compound separator, which was calculated by EDS elemental analysis, was as shown in Table 2.
Evaluation 4: FIG. 17B shows the XRD profile obtained in Example B6. In the XRD profile obtained, a peak was observed around 2θ = 7.2°. Generally, the (003) peak position of LDH is observed at 2θ = 11 to 12°, and therefore it is considered that the peak is the (003) peak of LDH shifted to the low angle side. Therefore, the peak cannot be called that of LDH, but it suggests that it is a peak derived from a compound similar to LDH (that is, an LDH-like compound). Two peaks observed at 20 < 2 θ° < 25 in the XRD profile are peaks derived from polyethylene constituting the porous substrate. Further, the interlayer distance in the layered crystal structure of the LDH-like compound was 1.2 nm.
Evaluation 5: As shown in Table 2, it was confirmed that the He permeability was 0.0 cm/min·atm, indicating that the denseness was extremely high.
Evaluation 6: As shown in Table 2, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 2, it was confirmed that short circuits due to zinc dendrites did not occur even after 300 cycles, indicating that the dendrite resistance was excellent.

### Example B7 (Reference)

An LDH-like compound separator was produced and evaluated in the same manner as in Example B6 except that the raw material aqueous solution was produced as follows in procedure (3) above.

### Production of Raw Material Aqueous Solution

As raw materials, magnesium nitrate hexahydrate (Mg(NO₃)_{2′}6H₂O, manufactured by KANTO CHEMICAL CO., INC.), yttrium nitrate n hydrate (Y(NO₃)₃·nH₂O, manufactured by FUJIFILM Wako Pure Chemical Corporation), and urea ((NH₂)₂CO, manufactured by Sigma-Aldrich Corporation) were prepared. The magnesium nitrate hexahydrate was weighed to 0.0075 mol/L and put into a beaker. Further, the yttrium nitrate n hydrate was weighed to 0.0075 mol/L and put into the beaker, and deionized water was added thereto so that the total amount was 75 ml. Then, the solution obtained was stirred. Urea weighed at a ratio urea/NO₃⁻ (molar ratio) of 25.6 was added into the solution, followed by further stirring, to obtain a raw material aqueous solution.

Evaluation 1: The SEM image of the surface microstructure of the LDH-like compound separator obtained in Example B7 (before roll pressing) was as shown in FIG. 18.
Evaluation 2: From the result that layered plaids could be observed, it was confirmed that the portion of the LDH-like compound separator other than the porous substrate was a compound with a layered crystal structure.
Evaluation 3: As a result of EDS elemental analysis, Mg, Al, Ti, and Y, which were constituent elements of the LDH-like compound, were detected on the surface of the LDH-like compound separator. Further, the composition ratio (atomic ratio) of Mg, Al, Ti, and Y on the surface of the LDH-like compound separator, which was calculated by EDS elemental analysis, was as shown in Table 2.
Evaluation 5: As shown in Table 2, it was confirmed that the He permeability was 0.0 cm/min·atm, indicating that the denseness was extremely high.
Evaluation 6: As shown in Table 2, it was confirmed that the ion conductivity was high.
Evaluation 7: The He permeability after immersion in alkali was 0.0 cm/min·atm, as in Evaluation 5, and it was confirmed that the He permeability did not change even after the immersion in alkali at a high temperature of 90° C. for one week, indicating that the alkali resistance was excellent.
Evaluation 8: As shown in Table 2, it was confirmed that short circuits due to zinc dendrites did not occur even after 300 cycles, indicating that the dendrite resistance was excellent.

### Example B8 (Comparison)

An LDH separator was produced and evaluated in the same manner as in Example B1 except that alumina sol coating was performed as follows, instead of procedure (2) above.

### Alumina Sol Coating on Porous Polymer Substrate

The substrate prepared in procedure (1) above was coated with an amorphous alumina sol (AI-ML15, manufactured by Taki Chemical Co., Ltd.) by dip coating. Dip coating was performed by immersing the substrate in 100 ml of the amorphous alumina sol and pulling it out perpendicularly, followed by drying at room temperature for 3 hours.

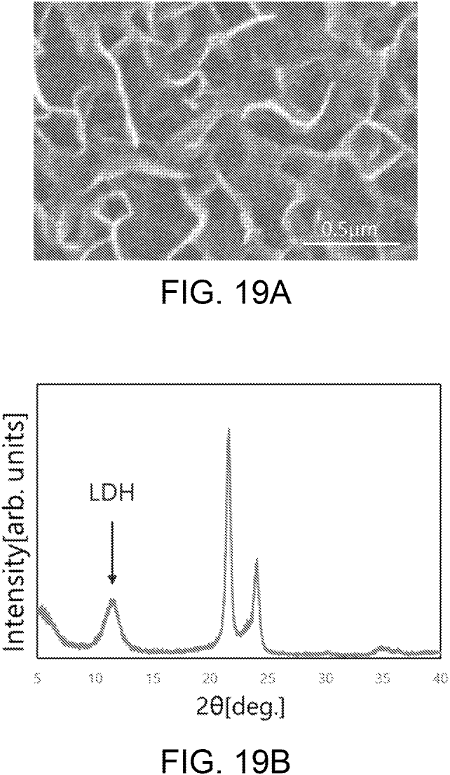

Evaluation 1: The SEM image of the surface microstructure of the LDH separator obtained in Example B8 (before roll pressing) was as shown in FIG. 19A.
Evaluation 2: From the result that layered plaids could be observed, it was confirmed that the portion of the LDH separator other than the porous substrate was a compound with a layered crystal structure.
Evaluation 3: As a result of EDS elemental analysis, Mg and Al, which were constituent elements of LDH, were detected on the surface of the LDH separator. Further, the composition ratio (atomic ratio) of Mg and Al on the surface of the LDH separator, which was calculated by EDS elemental analysis, was as shown in Table 2.
Evaluation 4: FIG. 19B shows the XRD profile obtained in Example B8. From a peak around 2θ = 11.5° in the XRD profile obtained, the LDH separator obtained in Example B8 was identified to be an LDH (hydrotalcite compound). This identification was performed using the diffraction peak of the LDH (hydrotalcite compound) described in JCPDS card NO. 35-0964. Two peaks observed at 20 < 2 θ° < 25 in the XRD profile are peaks derived from polyethylene constituting the porous substrate.
Evaluation 5: As shown in Table 2, it was confirmed that the He permeability was 0.0 cm/min·atm, indicating that the denseness was extremely high.
Evaluation 6: As shown in Table 2, it was confirmed that the ion conductivity was high.
Evaluation 7: As a result of the immersion in alkali at a high temperature of 90° C. for one week, the He permeability that was 0.0 cm/min atm in Evaluation 5 was over 10 cm/min·atm, revealing that the alkali resistance was poor.
Evaluation 8: As shown in Table 2, short circuits due to zinc dendrites occurred in less than 300 cycles, revealing that the dendrite resistance was poor.

[Table 2]

TABLE 2

| | LDH-like compound or composition of LDH | Evaluation of hydroxide ion-conductive separator | | | | |
|---|---|---|---|---|---|---|
| | | Composition ratio (Atomic ratio) | He permeation (cm/min·atm) | Ion conductivity (mS/cm) | Alkali resistance | Dendrite resistance |
| | | | | | Presence or absence of change in He permeability | Presence or absence of short circuits |
| Example B1^{#} | Mg-Ti-LDH-like | Mg:Ti=6:94 | 0.0 | 3.0 | Absent | Absent |
| Example B2^{#} | Mg-Ti-LDH-like | Mg:Ti=20:80 | 0.0 | 2.0 | Absent | Absent |
| Example B3^{#} | Mg-(Ti,Y)-LDH-like | Mg:Ti:Y=5:83:12 | 0.0 | 3.0 | Absent | Absent |
| Example B4^{#} | Mg-(Ti,Y,Al)-LDH-like | Mg:Al:Ti:Y=7:3:79:12 | 0.0 | 3.1 | Absent | Absent |
| Example B5^{#} | Mg-(Ti,Y)-LDH-like | Mg:Ti:Y=6:88:6 | 0.0 | 3.0 | Absent | Absent |
| Example B6^{#} | Mg-(Ti,Y,Al)-LDH-like | Mg:Al:Ti:Y=5:2:67:25 | 0.0 | 3.1 | Absent | Absent |
| Example B7^{#} | Mg-(Ti,Y,Al)-LDH-like | Mg:Al:Ti:Y=15:1:47:37 | 0.0 | 2.9 | Absent | Absent |
| Example B8* | Mg-Al-LDH | Mg:Al=67:32 | 0.0 | 2.7 | Present | Present |

Symbol ^{#} represents a reference example.
Symbol * represents a comparative example.

### Examples C1 to C9

Examples C1 to C9 shown below are reference examples for LDH-like compound separators. The method for evaluating the LDH-like compound separators produced in the following examples was the same as in Examples B1 to B8, except that the composition ratio (atomic ratio) of Mg: Al: Ti: Y: additive element M was calculated in Evaluation 3.

### Example C1 (Reference)

### Preparation of Polymer Porous Substrate

A commercially available polyethylene microporous membrane having a porosity of 50%, an average pore diameter of 0.1 µm, and a thickness of 20 µm was prepared as a polymer porous substrate and cut out to a size of 2.0 cm × 2.0 cm.

### Coating of Titania▪ Yttria▪ Alumina Sol on Polymer Porous Substrate

A titanium dioxide sol solution (M6, manufactured by Taki Chemical Co., Ltd.), an yttrium sol, and an amorphous alumina solution (Al-ML15, manufactured by Taki Chemical Co. Ltd.) were mixed so that Ti/(Y + Al) (molar ratio) = 2, and Y/Al (molar ratio) = 8. The substrate prepared in (1) above was coated with the mixed solution by dip coating. The dip coating was carried out by dipping the substrate into 100 ml of the mixed solution, pulling up the coating substrate vertically, and allowing it to dry for 3 hours at room temperature.

### Preparation of Raw Material Aqueous Solution (I)

Magnesium nitrate hexahydrate (Mg(NO₃)₂·6H₂O, manufactured by Kanto Chemical Co., Inc.) and urea ((NH₂)₂CO, manufactured by Sigma-Aldrich Co. LLC) were prepared as raw materials. Magnesium nitrate hexahydrate was weighed so that it would be 0.015 mol/L and placed in a beaker, and ion-exchanged water was added therein to make a total amount of 75 ml. After stirring the obtained solution, the urea weighed at a ratio that urea/NO₃- (molar ratio) = 48 was added to the solution, and the mixture was further stirred to obtain a raw material aqueous solution (I).

### Membrane Formation by Hydrothermal Treatment

Both the raw material aqueous solution (I) and the dip-coated substrate were sealed in a Teflon® airtight container (autoclave container having a content of 100 ml and an outer side jacket made of stainless steel). At this time, a substrate was fixed while being floated from the bottom of the Teflon® airtight container, and installed vertically so that the solution was in contact with both sides of the substrate. Thereafter, an LDH-like compound was formed on the surface and the inside of the substrate by subjecting it to hydrothermal treatment at a hydrothermal temperature of 120° C. for 22 hours. With an elapse of the predetermined time, the substrate was taken out from the airtight container, washed with ion-exchanged water, and dried at 70° C. for 10 hours to form an LDH-like compound inside the pores of the porous substrate.

### Preparation of Raw Material Aqueous Solution (II)

Indium sulfate n-hydrate (In₂(SO₄)₃▪nH₂O, manufactured by FUJIFILM Wako Pure Chemical Corporation) was prepared as the raw material. The Indium sulfate n-hydrate was weighed so that it would be 0.0075 mol/L and placed in a beaker, to which ion-exchanged water was added to make a total volume 75 ml. The resulting solution was stirred to obtain a raw material aqueous solution (II).

### Addition of Indium by Immersion Treatment

In a Teflon® airtight container (autoclave container having a content of 100 ml and an outer side jacket made of stainless steel), the raw material aqueous solution (II) and the LDH-like compound separator obtained in (4) above were enclosed together. At that time, a substrate was fixed while being floated from the bottom of the Teflon® airtight container and arranged vertically so that the solution was in contact with both sides of the substrate. Thereafter Indium was added on the substrate by subjecting it to immersion treatment at 30° C. for 1 hour. With an elapse of the predetermined time, the substrate was taken out from the airtight container, washed with ion-exchanged water, and dried at 70° C. for 10 hours to obtain an LDH-like compound separator with Indium added thereon.

### Densification by Roll Pressing

The LDH-like compound separator was sandwiched between a pair of PET films (Lumiler® manufactured by Toray Industries, Inc., thickness of 40 µm), and roll-pressed at a roll rotation speed of 3 mm/s, a roller heating temperature of 70° C., and a roll gap of 70 µm to obtain a further densified LDH-like compound separator.

### Evaluation Result

Various evaluations were conducted on the LDH-like compound separators obtained. The results were as follows.

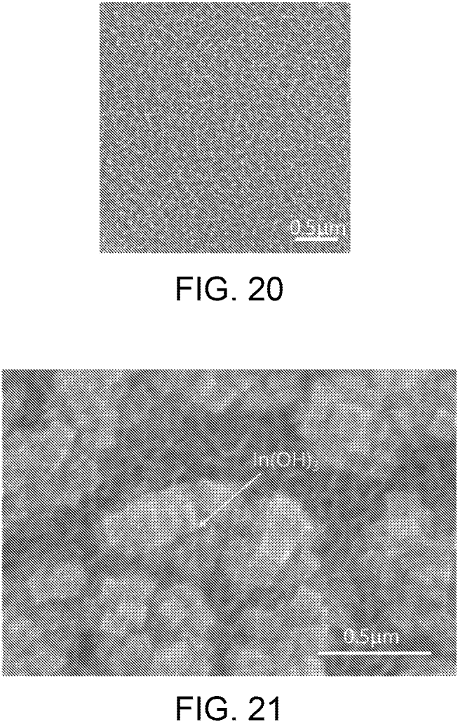

Evaluation 1: The SEM image of surface microstructure of the LDH-like compound separator obtained in Example C1 (before having been roll pressed) was shown in FIG. 20.
-Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Al, Ti, Y, and In were detected on the surface of the LDH-like compound separator. Moreover, the composition ratio (atomic ratio) of Al, Ti, Y, and In on the surface of the LDH-like compound separator, calculated by EDS elemental analysis was as shown in Table 3.
Evaluation 5: As shown in Table 3, the extremely high denseness was confirmed by a He permeability of 0.0 cm/min▪ atm.
Evaluation 6: As shown in Table 3, the high ionic conductivity was confirmed.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 3, the excellent dendrite resistance was confirmed in that there was no short circuit due to zinc dendrites even after 300 cycles.

### Example C2 (Reference)

An LDH-like compound separator was fabricated and evaluated in the same manner as in Example C1 except that the time of immersion treatment was changed to 24 hours in indium addition by the immersion treatment of (6) above.

Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Al, Ti, Y, and In were detected on the surface of the LDH-like compound separator. Moreover, the composition ratio (atomic ratio) of Al, Ti, Y, and In on the surface of the LDH-like compound separator, calculated by EDS elemental analysis was as shown in Table 3.
Evaluation 5: As shown in Table 3, the extremely high denseness was confirmed by a He permeability of 0.0 cm/min▪atm.
Evaluation 6: The high ionic conductivity was confirmed, as shown in Table 3.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 3, no short circuit caused by zinc dendrite occurred even after 300 cycles, confirming the excellent dendrite resistance.

### Example C3 (Reference)

An LDH-like compound separator was fabricated and evaluated in the same manner as in Example C1 except that the titania-yttria sol coating was carried out as follows instead of (2) above.

### Coating of Titania-Yttria Sol on Polymer Porous Substrate

A titanium dioxide sol solution (M6, manufactured by Taki Chemical Co., Ltd.) and an yttrium sol were mixed so that Ti/Y (molar ratio) = 2. The substrate prepared in (1) above was coated with the obtained mixed solution by dip coating. The dip coating was carried out by dipping the substrate into 100 ml of the mixed solution, pulling up the coating substrate vertically, and allowing it to dry for 3 hours at room temperature.

Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Ti, Y, and In were detected on the surface of the LDH-like compound separator. Moreover, the composition ratio (atomic ratio) of Ti, Y, and In on the surface of the LDH-like compound separator, calculated by EDS elemental analysis was as shown in Table 3.
Evaluation 5: As shown in Table 3, the extremely high denseness was confirmed by a He permeability of 0.0 cm/min▪atm.
Evaluation 6: The high ionic conductivity was confirmed, as shown in Table 3.
Evaluation 7: The He permeability after alkaline immersion was 0.0 cm/min▪ atm, as in Evaluation 5, and the He permeability remained unchanged even over one week of alkaline immersion at the elevated temperature of 90° C., confirming the excellent alkali resistance.
Evaluation 8: As shown in Table 3, no short circuit caused by zinc dendrite occurred even after 300 cycles, confirming the excellent dendrite resistance.

### Example C4 (Reference)

An LDH-like compound separator was fabricated and evaluated in the same manner as in Example C1 except that the preparation of the raw material aqueous solution (II) in (5) above was carried out as follows, and bismuth was added by immersion treatment as follows instead of (6) above.

### Preparation of Raw Material Aqueous Solution (II)

Bismuth nitrate pentahydrate (Bi(NO₃)₃▪5H₂O) was prepared as the raw material. The bismuth nitrate pentahydrate was weighed so that it would be 0.00075 mol/L and placed in a beaker, to which ion-exchanged water was added to make a total volume 75 ml. The resulting solution was stirred to obtain a raw material aqueous solution (II).

### Addition of Bismuth by Immersion Treatment

In a Teflon® airtight container (autoclave container having a content of 100 ml and an outer side jacket made of stainless steel), the raw material aqueous solution (II) and the LDH-like compound separator obtained in (4) above were enclosed together. At that time, a substrate was fixed while being floated from the bottom of the Teflon® airtight container and arranged vertically so that the solution was in contact with both sides of the substrate. Thereafter bismuth was added on the substrate by subjecting it to immersion treatment at 30° C. for 1 hour. With an elapse of the predetermined time, the substrate was taken out from the airtight container, washed with ion-exchanged water, and dried at 70° C. for 10 hours to obtain an LDH-like compound separator with bismuth added thereon.

Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Mg, Al, Ti, Y, and Bi were detected on the surface of the LDH-like compound separator. Moreover, the composition ratio (atomic ratio) of Mg, Al, Ti, Y, and Bi on the surface of the LDH-like compound separator, calculated by EDS elemental analysis was as shown in Table 3.
Evaluation 5: As shown in Table 3, the extremely high denseness was confirmed by a He permeability of 0.0 cm/min▪ atm.
Evaluation 6: The high ionic conductivity was confirmed, as shown in Table 3.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 3, no short circuit caused by zinc dendrite occurred even after 300 cycles, confirming the excellent dendrite resistance.

### Example C5 (Reference)

An LDH-like compound separator was fabricated and evaluated in the same manner as in Example C4 except that the time of immersion treatment was changed to 12 hours in bismuth addition by the immersion treatment described above.

Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Mg, Al, Ti, Y, and Bi were detected on the surface of the LDH-like compound separator. Moreover, the composition ratio (atomic ratio) of Mg, Al, Ti, Y, and Bi on the surface of the LDH-like compound separator, calculated by EDS elemental analysis was as shown in Table 3.
Evaluation 5: As shown in Table 3, the extremely high denseness was confirmed by a He permeability of 0.0 cm/min▪atm.
Evaluation 6: The high ionic conductivity was confirmed, as shown in Table 3.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 3, no short circuit caused by zinc dendrite occurred even after 300 cycles, confirming the excellent dendrite resistance.

### Example C6 (Reference)

An LDH-like compound separator was fabricated and evaluated in the same manner as in Example C4 except that the time of immersion treatment was changed to 24 hours in bismuth addition by the immersion treatment described above.

Evaluation 2: From the observation result of layered lattice stripes, the portion other than the porous substrate of the LDH-like compound separator was confirmed to be a compound having a layered crystal structure
Evaluation 3: As a result of EDS elemental analysis, the constituent elements of the LDH-like compound that were Mg, Al, Ti, Y, and Bi were detected on the surface of the LDH-like compound separator. Moreover, the composition ratio (atomic ratio) of Mg, Al, Ti, Y, and Bi on the surface of the LDH-like compound separator, calculated by EDS elemental analysis was as shown in Table 3.
Evaluation 5: As shown in Table 3, the extremely high denseness was confirmed by a He permeability of 0.0 cm/min▪ atm.
Evaluation 6: The high ionic conductivity was confirmed, as shown in Table 3.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 3, no short circuit caused by zinc dendrite occurred even after 300 cycles, confirming the excellent dendrite resistance.

### Example C7 (Reference)

An LDH-like compound separator was fabricated and evaluated in the same manner as in Example C1 except that the preparation of the raw material aqueous solution (II) in (5) above was carried out as follows, and calcium was added by immersion treatment as follows instead of (6) above.

### Preparation of Raw Material Aqueous Solution (II)

Calcium nitrate tetrahydrate (Ca(NO₃)₂▪4H₂O) was prepared as the raw material. The calcium nitrate tetrahydrate was weighed so that it would be 0.015 mol/L and placed in a beaker, to which ion-exchanged water was added to make a total volume 75 ml. The resulting solution was stirred to obtain a raw material aqueous solution (II).

### Addition of Calcium by Immersion Treatment

In a Teflon® airtight container (autoclave container having a content of 100 ml and an outer side jacket made of stainless steel), the raw material aqueous solution (II) and the LDH-like compound separator obtained in (4) above were enclosed together. At that time, a substrate was fixed while being floated from the bottom of the Teflon® airtight container and arranged vertically so that the solution was in contact with both sides of the substrate. Thereafter calcium was added on the substrate by subjecting it to immersion treatment at 30° C. for 6 hours. With an elapse of the predetermined time, the substrate was taken out from the airtight container, washed with ion-exchanged water, and dried at 70° C. for 10 hours to obtain an LDH-like compound separator with calcium added thereon.

Evaluation 2: From the observation result of layered lattice stripes, the portion other than the porous substrate of the LDH-like compound separator was confirmed to be a compound having a layered crystal structure
Evaluation 3: As a result of EDS elemental analysis, the constituent elements of the LDH-like compound that were Mg, Al, Ti, Y, and Ca were detected on the surface of the LDH-like compound separator. Moreover, the composition ratio (atomic ratio) of Mg, Al, Ti, Y, and Ca on the surface of the LDH-like compound separator, calculated by EDS elemental analysis was as shown in Table 3.
Evaluation 5: As shown in Table 3, the extremely high denseness was confirmed by a He permeability of 0.0 cm/min▪atm.
Evaluation 6: The high ionic conductivity was confirmed, as shown in Table 3.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 3, no short circuit caused by zinc dendrite occurred even after 300 cycles, confirming the excellent dendrite resistance.

### Example C8 (Reference)

An LDH-like compound separator was fabricated and evaluated in the same manner as in Example C1 except that the preparation of the raw material aqueous solution (II) in (5) above was carried out as follows, and strontium was added by immersion treatment as follows instead of (6) above.

### Preparation of Raw Material Aqueous Solution (II)

Strontium nitrate (Sr(NO₃)₂) was prepared as the raw material. The strontium nitrate was weighed so that it would be 0.015 mol/L and placed in a beaker, to which ion-exchanged water was added to make a total volume 75 ml. The resulting solution was stirred to obtain a raw material aqueous solution (II).

### Addition of Strontium by Immersion Treatment

In a Teflon® airtight container (autoclave container having a content of 100 ml and an outer side jacket made of stainless steel), the raw material aqueous solution (II) and the LDH-like compound separator obtained in (4) above were enclosed together. At that time, a substrate was fixed while being floated from the bottom of the Teflon® airtight container and arranged vertically so that the solution was in contact with both sides of the substrate. Thereafter strontium was added on the substrate by subjecting it to immersion treatment at 30° C. for 6 hours. With an elapse of the predetermined time, the substrate was taken out from the airtight container, washed with ion-exchanged water, and dried at 70° C. for 10 hours to obtain an LDH-like compound separator with strontium added thereon.

Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Mg, Al, Ti, Y, and Sr were detected on the surface of the LDH-like compound separator. Moreover, the composition ratio (atomic ratio) of Mg, Al, Ti, Y, and Sr on the surface of the LDH-like compound separator, calculated by EDS elemental analysis was as shown in Table 3.
Evaluation 5: As shown in Table 3, the extremely high denseness was confirmed by a He permeability of 0.0 cm/min▪atm.
Evaluation 6: The high ionic conductivity was confirmed, as shown in Table 3.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 3, no short circuit caused by zinc dendrite occurred even after 300 cycles, confirming the excellent dendrite resistance.

### Example C9 (Reference)

An LDH-like compound separator was fabricated and evaluated in the same manner as in Example C1 except that the preparation of the raw material aqueous solution (II) in (5) above was carried out as follows, and barium was added by immersion treatment as follows instead of (6) above.

### Preparation of Raw Material Aqueous Solution (II)

Barium nitrate (Ba(NO₃)₂) was prepared as the raw material. The barium nitrate was weighed so that it would be 0.015 mol/L and placed in a beaker, to which ion-exchanged water was added to make a total volume 75 ml. The resulting solution was stirred to obtain a raw material aqueous solution (II).

### Addition of Barium by Immersion Treatment

In a Teflon® airtight container (autoclave container having a content of 100 ml and an outer side jacket made of stainless steel), the raw material aqueous solution (II) and the LDH-like compound separator obtained in (4) above were enclosed together. At that time, a substrate was fixed while being floated from the bottom of the Teflon® airtight container and arranged vertically so that the solution was in contact with both sides of the substrate. Thereafter barium was added on the substrate by subjecting it to immersion treatment at 30° C. for 6 hours. With an elapse of the predetermined time, the substrate was taken out from the airtight container, washed with ion-exchanged water, and dried at 70° C. for 10 hours to obtain an LDH-like compound separator with barium added thereon.

Evaluation 2: From the observation result of layered lattice stripes, the portion other than the porous substrate of the LDH-like compound separator was confirmed to be a compound having a layered crystal structure.
Evaluation 3: As a result of EDS elemental analysis, the constituent elements of the LDH-like compound that were Al, Ti, Y, and Ba were detected on the surface of the LDH-like compound separator. Moreover, the composition ratio (atomic ratio) of Al, Ti, Y, and Ba on the surface of the LDH-like compound separator, calculated by EDS elemental analysis was as shown in Table 3.
Evaluation 5: As shown in Table 3, the extremely high denseness was confirmed by a He permeability of 0.0 cm/min▪atm.
Evaluation 6: The high ionic conductivity was confirmed, as shown in Table 3.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 3, no short circuit caused by zinc dendrite occurred even after 300 cycles, confirming the excellent dendrite resistance.

[Table 3]

TABLE 3

| | LDH-like compound or LDH composition | Composition ratio (atomic ratio relative to 100 of the total amount of Mg+AI+Ti+Y+M) | M/(Mg+AI +Ti+Y+M) | Evaluation of hydroxide ion-conductive separator | | | |
|---|---|---|---|---|---|---|---|
| | | | | He permeability (cm/min▪atm) | Ion conductivity (mS/cm) | Alkali resistance | Dendrite resistance |
| | | | | | | Presence or absence of change in He permeability | Presence or absence of short circuit |
| Example C1^{#} | Al,Ti,Y,ln-LDH-like | Mg:0, Al:2, Ti:78, Y:8, In:12 | 0.12 (M=ln) | 0.0 | 3.1 | Absent | Absent |
| Example C2^{#} | Al,Ti,Y,ln-LDH-like | Mg:0, AI:1, Ti:56, Y:11, In:32 | 0.32 (M=ln) | 0.0 | 3.1 | Absent | Absent |
| Example C3^{#} | Ti,Y,In-LDH-like | Mg:0, Al:0, Ti:78, Y:8, In:14 | 0.14 (M=ln) | 0.0 | 3.0 | Absent | Absent |
| Example C4^{#} | Mg,AI,Ti,Y,Bi-LDH-like | Mg:2, Al:2, Ti:81 , Y:12, Bi:3 | 0.03 (M=Bi) | 0.0 | 2.9 | Absent | Absent |
| Example C5^{#} | Mg,Al,Ti,Y,Bi-LDH-like | Mg:2, Al:2, Ti:72, Y:10, Bi:14 | 0.14 (M=Bi) | 0.0 | 2.8 | Absent | Absent |
| Example C6^{#} | Mg,Al,Ti,Y,Bi-LDH-like | Mg:1, Al:1, Ti:66, Y:7, Bi:25 | 0.25 (M=Bi) | 0.0 | 2.8 | Absent | Absent |
| Example C7^{#} | Mg,Al,Ti,Y,Ca-LDH-like | Mg:1, Al:3, Ti:73, Y:15, Ca:8 | 0.08 (M=Ca) | 0.0 | 2.8 | Absent | Absent |
| Example C8^{#} | Mg,Al,Ti,Y,Sr-LDH-like | Mg:1, Al:3, Ti:74, Y:14, Sr:8 | 0.08 (M=Sr) | 0.0 | 3.0 | Absent | Absent |
| Example C9^{#} | Al,Ti,Y,Ba-LDH-like | Mg:0, Al:4, Ti:71, Y:14, Ba:11 | 0.11 (M=Ba) | 0.0 | 2.8 | Absent | Absent |
| Example B8* | Mg,Al-LDH | Mg:68 Al:32 | 0 | 0.0 | 2.7 | Present | Present |

Symbol ^{#} represents a reference example.
Symbol * represents a comparative example.

### [Examples D1 and D2]

Examples D1 and D2 shown below are reference examples for LDH-like compound separators. The method for evaluating the LDH-like compound separators produced in the following examples was the same as in Examples B1 to B8, except that the composition ratio (atomic ratio) of Mg: Al: Ti: Y: In was calculated in Evaluation 3.

### Example D1 (Reference)

### Preparation of Polymer Porous Substrate

A commercially available polyethylene microporous membrane having a porosity of 50%, an average pore diameter of 0.1 µm, and a thickness of 20 µm was prepared as a polymer porous substrate and cut out to a size of 2.0 cm × 2.0 cm.

### Coating of Titania▪ Yttria▪ Alumina Sol on Polymer Porous Substrate

A titanium dioxide sol solution (M6, manufactured by Taki Chemical Co., Ltd.), an yttrium sol, and an amorphous alumina solution (AI-ML15, manufactured by Taki Chemical Co. Ltd.) were mixed so that Ti/(Y + Al) (molar ratio) = 2, and Y/AI (molar ratio) = 8. The substrate prepared in (1) above was coated with the mixed solution by dip coating. The dip coating was carried out by dipping the substrate into 100 ml of the mixed solution, pulling up the coating substrate vertically, and allowing it to dry for 3 hours at room tem perature.

### Preparation of Raw Material Aqueous Solution

As the raw materials, magnesium nitrate hexahydrate (Mg(NO₃)₂ •6H₂O, manufactured by Kanto Chemical Co., Inc.), indium sulfate n-hydrate (In(SO₄)₃ •nH₂O, manufactured by FUJIFILM Wako Pure Chemicals Corporation), and urea ((NH₂)₂CO, manufactured by Sigma-Aldrich Co. LLC) were prepared. Magnesium nitrate hexahydrate, indium sulfate n-hydrate, and the urea were weighed so as to adjust the concentrations thereof to 0.0075 mol/L, 0.0075 mol/L, and 1.44 mol/L, respectively and placed in a beaker, to which ion-exchanged water was added to make a total volume 75 ml. The resulting solution was stirred to obtain a raw material aqueous solution.

### Membrane Formation by Hydrothermal Treatment

Both the raw material aqueous solution and the dip-coated substrate were sealed in a Teflon® airtight container (autoclave container having a content of 100 ml and an outer side jacket made of stainless steel). At this time, a substrate was fixed while being floated from the bottom of the Teflon® airtight container, and installed vertically so that the solution was in contact with both sides of the substrate. Thereafter, an LDH-like compound was formed on the surface and the inside of the substrate by subjecting it to hydrothermal treatment at a hydrothermal temperature of 120° C. for 22 hours. With an elapse of the predetermined time, the substrate was taken out from the airtight container, washed with ion-exchanged water, and dried at 70° C. for 10 hours to allow for forming of a functional layer including an LDH-like compound and In(OH)₃ inside pores of the porous substrates. Thus, an LDH-like compound separator was obtained.

### Densification by Roll Pressing

The LDH-like compound separator was sandwiched between a pair of PET films (Lumiler® manufactured by Toray Industries, Inc., thickness of 40 µm), and roll-pressed at a roll rotation speed of 3 mm/s, a roller heating temperature of 70° C., and a roll gap of 70 µm to obtain a further densified LDH-like compound separator.

### Evaluation Result

Evaluations 1 to 8 were conducted for the LDH-like compound separators obtained. The results were as follows.

Evaluation 1: The SEM image of surface microstructure of the LDH-like compound separator obtained in Example D1 (before having been roll pressed) was shown in FIG. 21. As shown in FIG. 21, cubic crystals were confirmed to be observed on the surface of the LDH-like compound separator. The results of EDS elemental analysis and X-ray diffraction measurement described below demonstrate that these cubic crystals are presumed to be In(OH)₃.
Evaluation 2: From the observation result of layered lattice stripes, the LDH-like compound separator was confirmed to include a compound with a layered crystal structure.
Evaluation 3: As a result of EDS elemental analysis, the constituent elements of the LDH-like compound or In(OH)₃, which were Mg, Al, Ti, Y, and In were detected on the surface of the LDH-like compound separator. Moreover, in the cubic crystals present on the surface of the LDH-like compound separator, In that was a constituent element of In(OH)₃, was detected. The composition ratio (atomic ratio) of Mg, Al, Ti, Y, and In on the surface of the LDH-like compound separator, calculated by EDS elemental analysis is as shown in Table 4.
Evaluation 4: The peaks in the XRD profile obtained identified that In(OH)₃ was present in the LDH-like compound separator. This identification was conducted using the diffraction peaks of In(OH)₃ listed in JCPDS card No. 01-085-1338.
Evaluation 5: As shown in Table 4, the extremely high denseness was confirmed by a He permeability of 0.0 cm/min▪atm.
Evaluation 6: As shown in Table 4, the high ionic conductivity was confirmed.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 4, the excellent dendrite resistance was confirmed in that there was no short circuit due to zinc dendrites even after 300 cycles.

### Example D2 (Reference)

An LDH-like compound separator was fabricated and evaluated in the same manner as in Example D1 except that the titania-yttria sol coating was carried out as follows instead of (2) above.

### Coating of Titania-Yttria Sol on Polymer Porous Substrate

A titanium dioxide sol solution (M6, manufactured by Taki Chemical Co., Ltd.) and an yttrium sol were mixed so that Ti/Y (molar ratio) = 2. The substrate prepared in (1) above was coated with the obtained mixed solution by dip coating. The dip coating was carried out by dipping the substrate into 100 ml of the mixed solution, pulling up the coating substrate vertically, and allowing it to dry for 3 hours at room temperature.

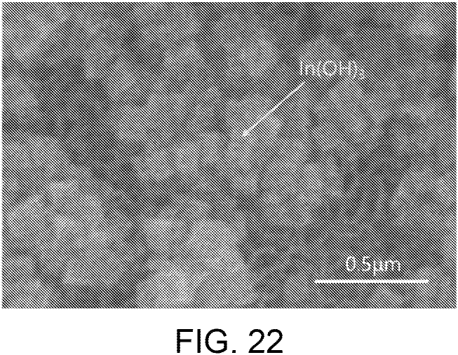

Evaluation 1: The SEM image of surface microstructure of the LDH-like compound separator obtained in Example D2 (before being roll pressed) is as shown in FIG. 22. As shown in FIG. 22, cubic crystals were confirmed to be observed on the surface of the LDH-like compound separator. The results of EDS elemental analysis and X-ray diffraction measurement described below demonstrate that these cubic crystals are presumed to be In(OH)₃.
Evaluation 2: From the observation result of layered lattice stripes, the LDH-like compound separator was confirmed to include a compound having a layered crystal structure.
Evaluation 3: As a result of EDS elemental analysis, the constituent elements of the LDH-like compound or In(OH)₃, which were Mg, Ti, Y, and In were detected on the surface of the LDH-like compound separator. Moreover, in the cubic crystals on the surface of the LDH-like compound separator, In that is a constituent element of In(OH)₃, was detected. The composition ratio (atomic ratio) of Mg, Ti, Y, and In on the surface of the LDH-like compound separator, calculated by EDS elemental analysis is as shown in Table 4.
Evaluation 4: The peaks in the XRD profile obtained identified that In(OH)₃ was present in the LDH-like compound separator. This identification was conducted using the diffraction peaks of In(OH)₃ listed in JCPDS card No. 01-085-1338.
Evaluation 5: As shown in Table 4, the extremely high denseness was confirmed by a He permeability of 0.0 cm/min▪atm.
Evaluation 6: The high ionic conductivity was confirmed, as shown in Table 4.
Evaluation 7: The He permeability after alkaline immersion was 0.0 cm/min▪atm, as in Evaluation 5, and the He permeability remained unchanged even over one week of alkaline immersion at the elevated temperature of 90° C., confirming the excellent alkali resistance.
Evaluation 8: As shown in Table 4, no short circuit caused by zinc dendrite occurred even after 300 cycles, confirming the excellent dendrite resistance.

[Table 4]

TABLE 4

| | Constitution of functional layer | Composition ratio (atomic ratio relative to 100 of total amount of Mg+Al+Ti+Y+In) | In/(Mg+AI+Ti+Y+ln) | Evaluation of hydroxide ion-conductive separator | | | |
|---|---|---|---|---|---|---|---|
| | | | | He permeability (cm/min-atm) | Ion conductivity (mS/cm) | Alkali resistance | Dendrite resistance |
| | | | | | | Presence or absence of change in He permeability | Presence or absence of short circuit |
| Example D1^{#} | LDH-like+ In(OH)₃ | Mg:7,Al:1, Ti:24, Y:3, In:65 | 0.65 | 0.0 | 2.7 | Absent | Absent |
| Example D2^{#} | LDH-like +In(OH)₃ | Mg:6, Al:0, 71:17, Y:3, In:74 | 0.74 | 0.0 | 2.8 | Absent | Absent |
| Example B8* | LDH | Mg:68, AI:32 | 0 | 0.0 | 2.7 | Present | Present |

Symbol ^{#} represents a reference example.
Symbol * represents a comparative example.

What is claimed is:

1. An LDH-like compound separator for secondary zinc batteries, comprising a porous substrate made of a polymer material; and a layered double hydroxide (LDH)-like compound plugging pores in the porous substrate, wherein the LDH-like compound separator has in its inside a dendrite buffer layer, wherein the dendrite buffer layer is at least one selected from the group consisting of:
(i) a pore-rich internal porous layer in the porous substrate, the internal porous layer being free from the LDH-like compound or deficient in the LDH-like compound;
(ii) a releasable interfacial layer, which is provided by two adjacent layers constituting part of the LDH-like compound separator being in releasable contact with each other; and
(iii) an internal gap layer being free from the LDH-like compound and the porous substrate, which is provided by two adjacent layers constituting part of the LDH-like compound separator being formed apart from each other.

2. The LDH-like compound separator according to claim 1, wherein the LDH-like compound is:
(a) a hydroxide and/or an oxide with a layered crystal structure, containing: Mg; and one or more elements, which include at least Ti, selected from the group consisting of Ti, Y, and AI, or
(b) a hydroxide and/or an oxide with a layered crystal structure, comprising (i) Ti, Y, and optionally AI and/or Mg, and (ii) at least one additive element M selected from the group consisting of In, Bi, Ca, Sr, and Ba, or
(c) a hydroxide and/or an oxide with a layered crystal structure, comprising Mg, Ti, Y, and optionally AI and/or In, wherein in (c) the LDH-like compound is present in a form of a mixture with In(OH)₃.

3. The LDH-like compound separator according to claim 1, wherein the LDH-like compound is incorporated over the entire thickness of the porous substrate other than the dendrite buffer layer.

4. The LDH-like compound separator according to claim 1, wherein the dendrite buffer layer is (i) a pore-rich internal porous layer in the porous substrate, the internal porous layer being free from the LDH-like compound or deficient in the LDH-like compound.

5. The LDH-like compound separator according to claim 1, wherein the dendrite buffer layer is (ii) a releasable interfacial layer, which is provided by two adjacent layers constituting part of the LDH-like compound separator being in releasable contact with each other.

6. The LDH-like compound separator according to claim 1, wherein the dendrite buffer layer is (iii) an internal gap layer being free from the LDH-like compound and the porous substrate, which is provided by two adjacent layers constituting part of the LDH-like compound separator being formed apart from each other.

7. The LDH-like compound separator according to claim 1, wherein the LDH-like compound separator has a helium permeability per unit area of 3.0 cm/atm ·min or less.

8. The LDH-like compound separator according to claim 1, wherein the polymer material is selected from the group consisting of polystyrene, poly(ether sulfone), polypropylene, epoxy resin, poly(phenylene sulfide), fluorocarbon resin, cellulose, nylon and polyethylene.

9. The LDH-like compound separator according to claim 1, consisting of the porous substrate and the LDH-like compound.

10. A secondary zinc battery comprising the LDH-like compound separator according to claim 1.
